(19) United States
(12) Patent Application Publication
(10) Pub. No.: US 2018/0046489 A1
(43) Pub. Date: Feb. 15, 2018

(54) STORAGE MEDIUM, METHOD, AND DEVICE

(71) Applicant: FUJITSU LIMITED, Kawasaki-shi (JP)

(72) Inventor: Koichi Onoue, Kawasaki (JP)

(73) Assignee: FUJITSU LIMITED, Kawasaki-shi (JP)

(21) Appl. No.: 15/597,563

(22) Filed: May 17, 2017

(30) Foreign Application Priority Data
Aug. 12, 2016 (JP) 2016-158605

(51) Int. Cl. G06F 9/455; G06F 9/48

(52) U.S. Cl. CPC G06F 9/45558; G06F 9/4831; G06F 2009/4557

(57) ABSTRACT

A storage medium stores a program that causes a computer to execute a process. The process includes, obtaining information on a virtual machine from among a plurality of virtual machines, migration information, first state information, and time information, determining a priority of each of the plurality of virtual machines based on the time information, identifying a first virtual machine group based on the migration information and the first state information, instructing each virtual machine included in the first virtual machine group to migrate to a physical machine of a migration destination based on the priority, obtaining second state information, identifying a second virtual machine group based on the migration information and the second state information, and instructing each virtual machine included in the second virtual machine group to migrate to the physical machine of the migration destination based on the priority.

### CROSS-REFERENCE TO RELATED APPLICATION

This application is based upon and claims the benefit of priority of the prior Japanese Patent Application No. 2016-158605, filed on Aug. 12, 2016, the entire contents of which are incorporated herein by reference.

### FIELD

The embodiment discussed herein is related to a storage medium, a method, and a device.

### BACKGROUND

In recent years, along with the improvement of the performance of physical machines, study of virtualization technology for integrating multiple Virtual Machines (VM) into one physical machine has been advanced. The virtualization technology lets, for instance, virtualization software (hereinafter also referred to as hypervisor) assign a physical machine to multiple virtual machines, and enables services to be provided by an application program (hereinafter also referred to as an application) installed in each of the virtual machines.

In the above-mentioned virtual machines, an administrator who manages the virtual machines (hereinafter also simply referred to as an administrator) performs migration (hereinafter referred to as migration) of a virtual machine between physical machines as desired, This allows the administrator to reallocate virtual machines according to a situation of usage of services by users, for instance. Thus, it is possible for the administrator to achieve efficient use of physical resources of the physical machine.

Related techniques are disclosed in, for example, Japanese Laid-open Patent Publication Nos. 2010-244524 and 2015-011569.

### SUMMARY

According to an aspect of the invention, a non-transitory storage medium stores a program that causes a computer to execute a process. The process includes, for each of a plurality of virtual machines set as targets for migration between a plurality of physical machines included in an information processing system, first obtaining information on a virtual machine from among the plurality of virtual machines, migration information, first state information, and time information, the migration information including information in which information on a physical machine at a migration source of the virtual machine and information on a physical machine at a migration destination of the virtual machine are associated with each other, the first state information indicating a state of each of the plurality of physical machines and the plurality of virtual machines, the time information indicating a time taken for the migration of each of the plurality of virtual machines between the plurality of physical machines, The process further includes first determining a priority of each of the plurality of virtual machines based on the time information, first identifying a first virtual machine group based on the migration information and the first state information, the first virtual machine group including each, virtual machine which is migratable to the physical machine of the migration destination, among the plurality of virtual machines, first instructing each virtual machine included in the first virtual machine group to migrate to the physical machine of the migration destination respectively, based on the determined priority. The process further includes, in response to completion of the migration of one virtual machine included in the first virtual machine group to the physical machine of the migration destination, second obtaining second state information indicating a state of each of the plurality of physical machines and the plurality of virtual machines, second identifying a second virtual machine group based on the migration information and the second state information, the second virtual machine group including each virtual machine which is migratable to the physical machine of the migration destination, among the plurality of virtual machines, and second instructing each virtual machine included in the second virtual machine group to migrate to the physical machine of the migration destination respectively, based on the determined priority.

The object and advantages of the invention will be realized and attained by means of the elements and combinations particularly pointed out in the claims.

It is to be understood that both the foregoing general description and the following detailed description are exemplary and explanatory and are not restrictive of the invention as claimed.

### BRIEF DESCRIPTION OF DRAWINGS

FIG. 1 illustrates the entire configuration of an information processing system;

FIG. 2 is a diagram for illustrating example virtual machine allocated in a physical machine;

FIG. 3 is a diagram for illustrating a hardware configuration of an information processing apparatus;

FIG. 4 is a functional block diagram of the information processing apparatus;

FIGS. 5 and 6 are flowcharts for illustrating the outline of migration control processing in a first embodiment;

FIGS. 7, 8, 9, 10, 11, 12, 13, and 14 are flowcharts for illustrating the details of the migration control processing in the first embodiment;

FIG. 15 is example migration target information;

FIG. 16 is an example of a partial dependence graph;

FIG. 17 is an example of a dependence graph;

FIG. 18A is example dependence virtual machine information and FIG. 18B is example of dependence virtual machine group information;

FIG. 19 is example priority information;

FIG. 20A is example physical machine state information, and FIG. 20B is example virtual machine state information;

FIG. 21 is example remaining physical resource information;

FIG. 22 is example remaining network resource information;

FIG. 23 is a diagram for illustrating an example network configuration between physical machines;

FIGS. 24A and 24B are diagrams for illustrating example migration candidate information, example migration determination information and example migration incomplete information;

FIG. 25 is example remaining network resource information;

FIGS. 26A and 26B are diagrams for illustrating example migration candidate information, example migration determination information and example migration incomplete information;

FIG. 27 is example remaining network resource information; and

FIGS. 28A, 28B, 29A, 29B, 30A and 30B are example migration candidate information, example migration determination information and example migration incomplete information.

### DESCRIPTION OF EMBODIMENT

When migration of a virtual machine as mentioned above is performed, an administrator sets, for instance, a physical machine with remaining physical resources to a migration destination among physical machines in which virtual machines operate, and performs the migration of the virtual machine. However, in this case, physical machines which may be set to a migration destination of a virtual machine are limited to those physical machines that have remaining physical resources at the present moment. Therefore, allocation of virtual machines after the migration of the virtual machines is performed may not be optimal allocation of the virtual machines from the viewpoint of efficient use of the physical resources of the physical machines.

To cope with this, an administrator may utilize mathematical programming such as an optimization solver, thereby making it possible to determine an allocation (hereinafter referred to as an optimal allocation) of virtual machines in advance, which enables the most efficient use of the physical resources of physical machines. However, in the allocation of virtual machines calculated by the mathematical programming, a situation of remaining physical resources of each physical machine during migration of each virtual machine, and a difference in the times taken for migration of the virtual machines are not taken into consideration. For this reason, it may be difficult for the administrator to identify a migration order of virtual machines for reallocating the virtual machines in the optimal allocation.

In an aspect of this embodiment, a migration order of virtual machines in reallocation of the virtual machines is determined

### Configuration of Information Processing System

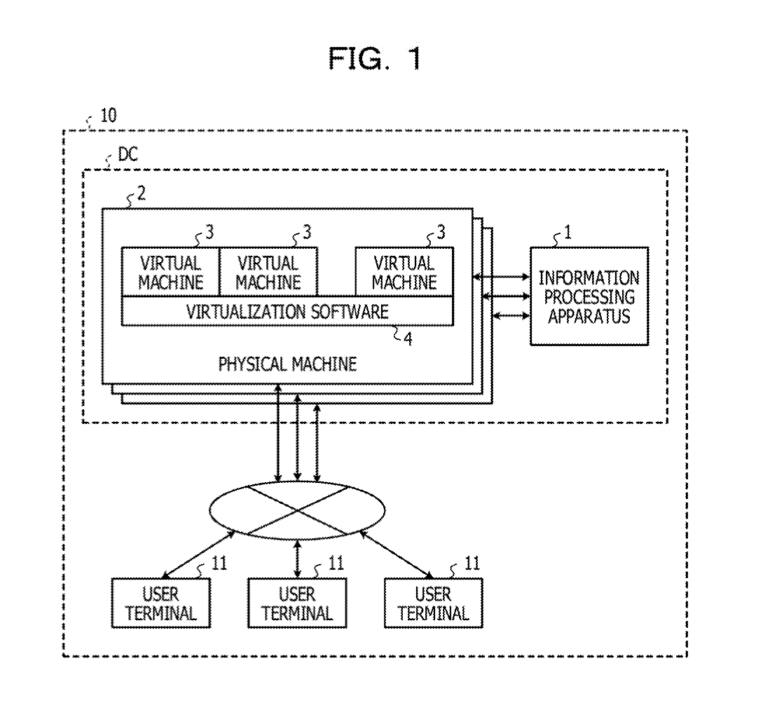

FIG. 1 illustrates the entire configuration of an information processing system. An information processing system 10 illustrated in FIG. 1 is a business system for providing services to users. In the information processing system 10 illustrated in FIG. 1, an information processing apparatus 1 and a physical machine 2 are provided in a data center DC. User terminals 11 are accessible to the data center DC via a network such as the Internet or the Intranet.

The physical machine 2 includes multiple physical machines, for instance. Each of the physical machines has a central processing unit (CPU), a dynamic random access memory (DRAM), and a large capacity memory such as a hard disk drive (HDD). The physical resources of the physical machine 2 are allocated to multiple virtual machines 3.

The information processing apparatus 1 is accessible to the virtual machines 3, and manages the virtual machines 3 generated in the physical machine 2. The information processing apparatus 1 may be generated by the virtual machines 3, for instance.

The virtual machines 3 provide their infrastructure to users via a network (hereinafter also referred to as a cloud service).

The cloud service is service that provides the foundation for implementing and operating a computer system via a network, that is, infrastructure such as the virtual machines 3 and a network. Also, a user selects, for instance, the specification for the virtual machines 3 via a user terminal 11, for instance, the clock frequency of a CPU, the capacity of a memory, the capacity of a hard disk and the communication bandwidth of a network. Then the user signs a contract with the cloud service. In addition, a user is allowed to monitor an operating state of the virtual machine 3 and to operate the virtual machine 3 via a user terminal 11, for instance.

A virtualization software 4 is an infrastructure software that allocates a CPU, a memory, a hard disk and a network of the physical machine 2 to the virtual machine 3 according to an instruction from the information processing apparatus 1, thereby causing the virtual machine 3 to operate. The virtualization software 4 is operated in the physical machine 2, for instance. In addition, the virtualization software 4 performs migration of the virtual machine 3 between physical machines 2, for instance,

### Example Virtual Machine Arranged in Physical Machine

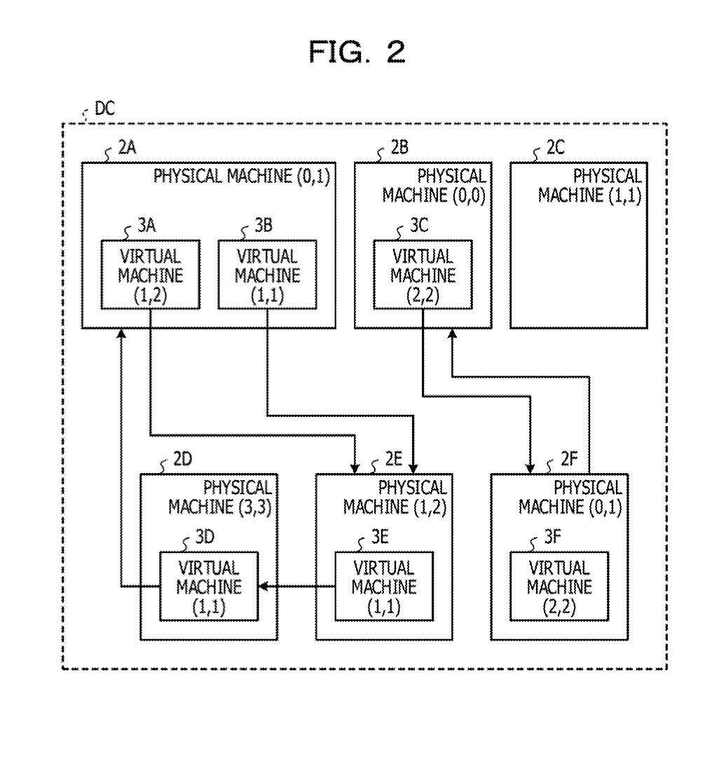

Next, an example virtual machine 3 allocated in the physical machine 2 will be described. FIG. 2 is a diagram for illustrating an example virtual machine allocated in a physical machine.

In the example illustrated in FIG. 2, physical machines 2A, 26, 2C, 2D, 2E, and 2F are allocated in the data center DC. A virtual machine 3A and a virtual machine 3B are allocated in the physical machine 2A, and a virtual machine 3C is allocated in the physical machine 2B. Also, virtual machines 3D, 3E, and 3F are allocated in the physical machines 2D, 2E, and 2F, respectively.

In the example illustrated in FIG. 2, “physical machine (0, 1)” in the physical machine 2A indicates that the available capacity in the disk of the physical machine 2A is “0 (GB)”, and the available capacity in the memory is “1 (GB)”. In the example illustrated in FIG. 2, “virtual machine (1, 2)” in the virtual machine 3A indicates that a use capacity of the disk for the virtual machine 3A to operate is “1 (GB)”, and a use capacity of the memory for the virtual machine 3A to operate is “2 (GB)”. A description of other physical machines 2 and virtual machines 3 in FIG. 2 will be omitted.

In the virtual machines 3 as illustrated in FIG. 2, the administrator performs migration of the virtual machines 3 between the physical machines 2 as desired. Thus, is possible for the administrator to reallocate the virtual machines 3 according to a situation of usage of services by users, for instance. Thus, it is possible for the administrator to achieve efficient use of the physical resources of the physical machines 2.

When migration of a virtual machine 3 is performed, the administrator performs migration, for instance, on a physical machine 2 with remaining physical resources among the physical machines 2 in which virtual machines 3 operate. However, in this case, physical machines 2 to which a virtual machine 3 is migratable are limited to those physical machines 2 that have remaining physical resources at the present moment, Therefore, allocation of the virtual machines 3 after the migration of the virtual machine 3 may not be optimal allocation of the virtual machine 3 from the viewpoint of efficient use of the physical resources of the physical machines 2,

To cope with this, the administrator may utilize mathematical programming (for instance, an optimization solver). Thus, it is possible for the administrator to calculate an optimal allocation of the virtual machines 3, which allows the most efficient use of the physical resources of the physical machines 2 as indicated by the arrows of FIG, 2. However, in the allocation of the virtual machines 3 calculated by the mathematical programming, a situation of remaining physical resources of the physical machines 2 during migration of each virtual machine 3 is not taken into consideration,

In the example illustrated in FIG. 2, the administrator has to migrate the virtual machine 3A and the virtual machine 3B from the physical machine 2A to the physical machine 2E. The total of the use capacities for the disk of the virtual machine 3A and the virtual machine 3B is “2 (GB)”and the total of the use capacities for the memory of the virtual machine 3A and the virtual machine 36 is “3 (GB)”. Therefore, in order to migrate the virtual machine 3A and the virtual machine 36 from the physical machine 2A to the physical machine 2E, in the physical machine 2E, available capacity in the disk has to be “2 (GB)” or greater, and available capacity in the memory has to be “3 (GB)” or greater.

However, in the example illustrated in FIG. 2, available capacity in the disk is “1 (GB)”, and available capacity in the memory is “2 (GB)” in the physical machine 2E. Therefore, the virtual machine 3A and the virtual machine 36 are not concurrently migratable to the physical machine 2E as illustrated in FIG. 2. In other words, one of the virtual machine 3A and the virtual machine 3B, which is not immediately migratable to the physical machine 2E, has to be migrated after the virtual machine 3E is migrated from the physical machine 2E to the physical machine 2D.

Also, in the example illustrated in FIG. 2, the administrator has to migrate the virtual machine 3C from the physical machine 26 to the physical machine 2F, and has to migrate the virtual machine 3F from the physical machine 2F to the physical machine 26. The use capacity in the disk of the virtual machine 3C is “2 (GB)”, and the use capacity in the memory of the virtual machine 3C is “2 (GB)”. Also, the total of the use capacity in the disk of the virtual machine 3F is “2 (GB)”, and the total of the use capacity in the memory of the virtual machine 3F is “2 (GB)”, Therefore, in order to migrate the virtual machine 3C from the physical machine 26 to the physical machine 2F, available capacity in the disk of the physical machine 2F has to be “2 (GB)” or greater, and available capacity in the memory has to be “2 (GB)” or greater. Also, in order to migrate the virtual machine 3F from the physical machine 2F to the physical machine 26, available capacity in the disk of the physical machine 2B has to be greater than or equal to “2 (GB)”, and available capacity in the memory has to be “2 (GB)” or greater.

However, in the example illustrated in FIG. 2, available capacity in the disk of the physical machine 2F is “0 (GB)”, and available capacity in the memory is “1 (GB)”. Also, in the example illustrated in FIG. 2, available capacity in the disk of the physical machine 2B is “0 (GB)”, and available capacity in the memory is “0 (GB)”.

Therefore, the virtual machine 3C and the virtual machine 3F are not concurrently migratable to the physical machine 2 as a migration destination.

Also, in the example illustrated in FIG. 2, the administrator has to migrate the virtual machine 3D from the physical machine 2D to the physical machine 2A. The use capacity in the disk of the virtual machine 3D is “1 (GB)” and the use capacity in the memory of the virtual machine 3D is “1 (GB)”. Therefore, in order to migrate the virtual machine 3D from the physical machine 2D to the physical machine 2A, available capacity in the disk of the physical machine 2A has to be “1 (GB)” or greater, and available capacity in the memory has to be “1 (GB)” or greater.

However, in the example illustrated in FIG. 2, available capacity in the disk of the physical machine 2A is “0 (GB)”, and available capacity in the memory is “1 (GB)”. Therefore, the virtual machine 3D is not migratable to the physical machine 2A. In other words, in this case, the virtual machine 3D has to be migrated to the physical machine 2A after the virtual machine 3A or the virtual machine 3B is migrated from the physical machine 2A to the physical machine 2E.

Therefore, even when the administrator calculates an optimal allocation utilizing mathematical programming, it may be difficult to identify a migration order of the virtual machines 3 for reallocating the virtual machines 3 in the optimal allocation.

In addition, the times taken for the virtual machines 3 to migrate between the physical machines 2 may be not fixed. Thus, due to the necessity for reducing the total time taken for migration of all the virtual machines 3, it is preferable for the administrator to determine a migration order of the virtual machines 3 in consideration of a difference in the times taken for migration of the virtual machines 3.

Thus, the information processing apparatus 1 in this embodiment determines a priority of each virtual machine 3 based on information (hereinafter also referred to as time information) which indicates the time taken for migration of each virtual machine 3 between physical machines 2. The information processing apparatus 1 identifies a virtual machine 3 (hereinafter also referred to as a first virtual machine group) which is migratable to the physical machine 2 at a migration destination based on information (hereinafter also referred to as migration information) on the physical machine 2 of the migration source and migration destination of each virtual machine 3, and state information (hereinafter also referred to as first state information) which indicates the state of each physical machine 2 and each virtual machine 3. In addition, the information processing apparatus 1 instructs each virtual machine 3 included in the first virtual machine group to migrate to the physical machine 2 at a migration destination based on the priority of the virtual machine 3.

Subsequently, the information processing apparatus 1 identifies a virtual machine 3 (hereinafter also referred to as a second virtual machine group) which is migratable to the physical machine 2 at a migration destination, based on the migration information and state information (hereinafter, referred to as second state information) indicating the state of each physical machine 2 and each virtual machine 3 after migration of one of the virtual machines 3 is completed. The information processing apparatus 1 then instructs each virtual machine 3 included in the second virtual machine group to migrate to the physical machine 2 at a migration destination based on the priority of the virtual machine 3.

Specifically, the information processing apparatus 1 determines a higher priority of the virtual machine 3, for instance for a larger time indicated by the time information of the virtual machine 3. Also, the information processing apparatus 1 determines a higher priority of a virtual machine 3, for instance for a larger number of virtual machines 3 each of which is not migratable to the physical machine 2 at a migration destination unless the virtual machine 3 is first migrated. The information processing apparatus 1 refers to the priority determined for each virtual machine 3, and determines an order of the virtual machines 3 for instructing migration to the physical machine 2 at a migration destination.

Thus, when multiple migratable virtual machines 3 are present in the physical machine 2 at a migration destination, the information processing apparatus 1 is able to preferentially migrate a virtual machine 3 that produces the greatest effect on reducing the time taken for migration of all the virtual machines 3. Thus, even when the times taken for migration of the virtual machines 3 are varied, it is possible for the information processing apparatus 1 to determine an order of migration that reduces the time taken for migration of all the virtual machines 3 to the physical machine 2 at a migration destination.

Also, when migration of one of the virtual machines 3 is completed, the information processing apparatus 1 again acquires the state information (the second state information) the reflects the state after migration of the virtual machine 3 is completed, and identifies a virtual machine 3 which is migratable to the physical machine 2 at a migration destination.

Thus, in response to a change in available state of the physical resource of each physical machine 2, the information processing apparatus 1 is able to identify a new virtual machine 3 which has become migratable. Thus, it is possible for the information processing apparatus 1 to update selection of a virtual machine 3 as desired for instructing migration to the physical machine 2 at a migration destination. Therefore, it is possible for the information processing apparatus 1 to search for an order of migration for reallocating virtual machines 3 based on the optimal allocation of the virtual machines 3.

### Hardware Configuration of Information Processing Apparatus

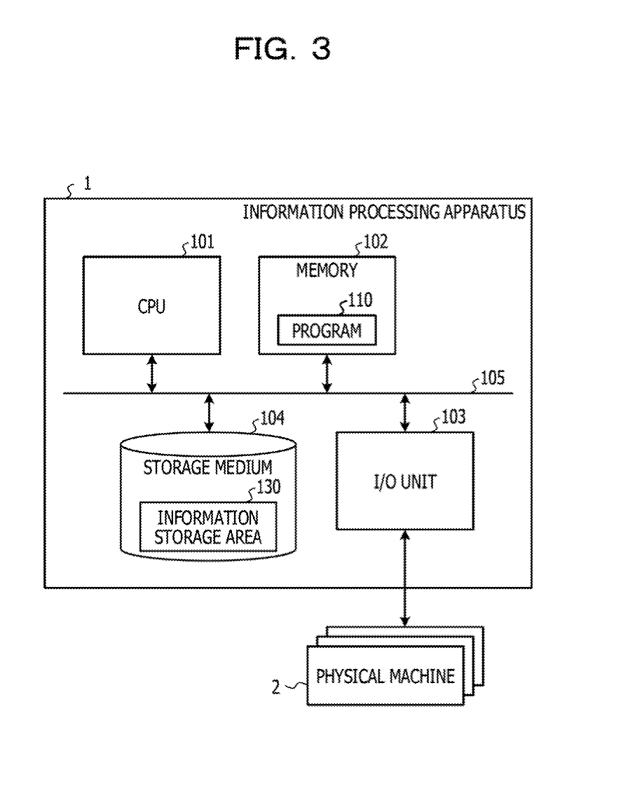

Next, the hardware configuration of the information processing apparatus 1 will be described. FIG. 3 is a diagram for illustrating the hardware configuration of the information processing apparatus.

The information processing apparatus 1 has a CPU 101 which is a processor, a memory 102, an external interface (I/O unit) 103, and a storage medium (storage) 104. Those components are coupled to each other via a bath 105.

The storage medium 104 stores a program 110 in a program storage area (not illustrated) in the storage medium 104 for executing the processing (hereinafter also referred to as migration control processing) that controls migration of the virtual machines 3.

As illustrated in FIG. 3, at the time of execution of the program 110, the CPU 101 loads the program 110 from the storage medium 104 into the memory 102, and cooperates with the program 110 to perform the migration control processing.

The storage medium 104 has, for instance, an information storage area 130 (hereinafter also referred to as a memory unit 130) that stores information which is used when the migration control processing is performed. Also, an external interface 103 communicates with the physical machines 2.

### Software Configuration of Information Processing Apparatus

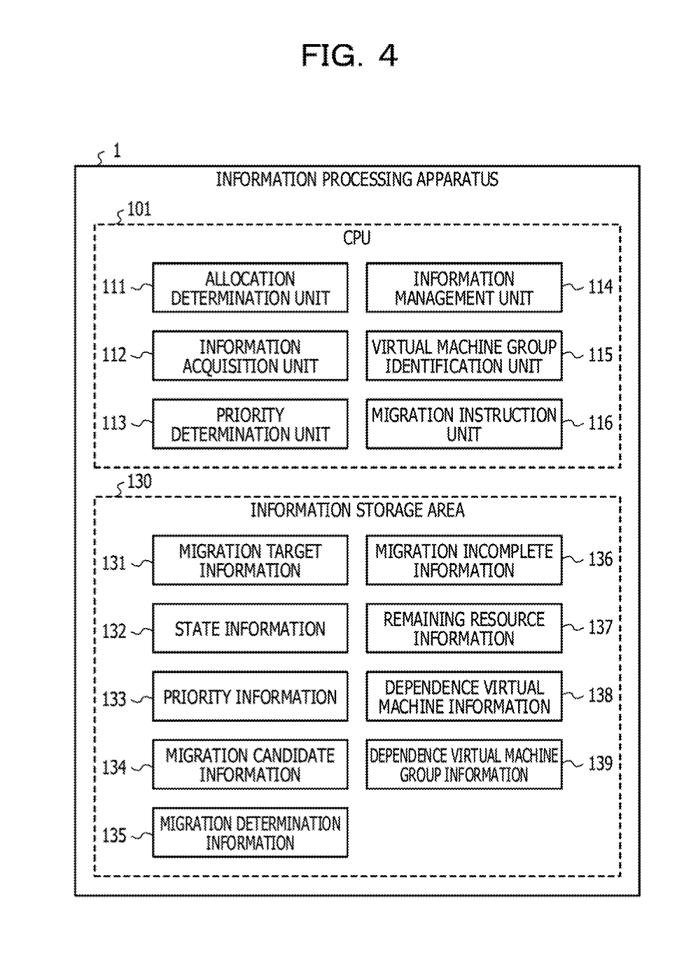

Next, the software configuration of the information processing apparatus 1 will be described. FIG. 4 is a functional block diagram of the information processing apparatus. The CPU 101 cooperates with the program 110, thereby operating as an allocation determination unit 111, an information acquisition unit 112, a priority determination unit 113, an information management unit 114, a virtual machine group identification unit 115, and a migration instruction unit 116.

As illustrated in FIG. 4, the information storage area 130 stores migration target information 131 (hereinafter also referred to as migration information 131), state information 132, priority information 133, migration candidate information 134, migration determination information 135, and migration incomplete information 136. Furthermore, as illustrated in FIG. 4, the information storage area 130 stores remaining resource information 137, dependence virtual machine information 138, and dependence virtual machine group information 139.

The allocation determination unit 111 utilizes mathematical programming (for instance, an optimization solver) to calculate the optimal allocation of the virtual machines 3, which allows the physical resources of the physical machines 2 to be used most efficiently. The allocation determination unit 111 then generates migration target information 131 which includes information on the calculated optimal allocation. The migration target information 131 is information in which information by which the virtual machine 3 is identifiable, information by which the physical machine 2 at a migration source of the virtual machine 3 is identifiable, and information by which the physical machine 2 at a migration destination of the virtual machine 3 is identifiable are associated with each other for each of multiple virtual machines 3 that migrate between the physical machines 2. Also, the migration target information 131 may include, for instance, the time (hereinafter also referred to as time information 131a) taken for migration of each virtual machine 3 between the physical machines 2. Hereinafter, description is given under the assumption that the migration target information 131 includes the time information 131a. An example of the migration target information 131 will be described later.

The information acquisition unit 112 acquires the migration target information 131 generated by the allocation determination unit 111. In addition, the information acquisition unit 112 acquires state information 132 (hereinafter also referred to as first state information 132a) that indicates the state of each of multiple physical machines 2 and multiple virtual machines 3. The state information 132 provides, for instance, information on available capacity in the physical resource of each of multiple physical machines 2, and information on the amount of use of the physical resource used for operating each of multiple virtual machines 3. An example of the state information 132 will be described later. In addition, the information acquisition unit 112 acquires, for instance, the time information 131a included in the migration target information 131.

Also, after migration of the virtual machine 3 is completed, the information acquisition unit 112 acquires the state information 132 (hereinafter also referred to as second state information 132b) that reflects a change in the state due to the completion of migration of the virtual machine

The priority determination unit 113 determines the priority of each of multiple virtual machines 3 based on the time information 131a included In the migration target information 131, The priority determination unit 113 then generates the priority information 133 that includes information indicating the determined priority.

The information management unit 114 generates the migration candidate information 134, the migration determination information 135, the migration incomplete information 136 and the remaining resource information 137. The migration candidate information 134 is information that identifies a virtual machine 3 migratable to the physical machine 2 at a migration destination among the virtual machines 3 each of which has to be migrated to the physical machine 2 at a migration destination. Also, the migration determination information 135 is information that identifies a virtual machine 3 which is migrating to the physical machine 2 at a migration destination among the virtual machines 3 with their information included in the migration candidate information 134. Also, the migration incomplete information 136 is information that identifies a virtual machine 3 which is not migratable to the physical machine 2 at a migration destination among the virtual machines 3 each of which has to be migrated to the physical machine 2 at a migration destination. Furthermore, the remaining resource information 137 is information on the current remaining amount of the physical resource of each physical machine 2 and on the current remaining amount of the network resource between the physical machines 2. An example of each of the migration candidate information 134, the migration determination information 135, the migration incomplete information 136 and the remaining resource information 137 will be described later.

The virtual machine group identification unit 115 identifies a virtual machine group (the first virtual machine group) that includes virtual machines 3 each migratable to the physical machine 2 at a migration destination among multiple virtual machines 3, based on the migration information 131 and the first state information 132a. Also, the virtual machine group identification unit 115 identifies a virtual machine group (the second virtual machine group) that includes virtual machines 3 each migratable to the physical machine 2 at a migration destination among multiple virtual machines 3, based on the migration information 131 and the second state information 132b.

The migration instruction unit 116 instructs each virtual machine 3 included in the first virtual machine group to migrate to the physical machine 2 at a migration destination based on priority information 133. In addition, the migration instruction unit 116 instructs each virtual machine 3 included in the second virtual machine group to migrate to the physical machine 2 at a migration destination based on priority information 133.

It is to be noted that hereinafter, description is given under the assumption that the physical resources of the physical machine 2 are the disk capacity and the memory capacity of the physical machine 2. However, the physical resources of the physical machine 2 may include, for instance, the number of CPUs and the usage rate of each CPU. The information processing apparatus 1 may perform the migration control processing by utilizing information on at least one of the disk capacity, the memory capacity, the number of CPUs, and the amount of CPUs, for instance. The dependence virtual machine information 138 and the dependence virtual machine group information 139 will be described later.

### Outline of First Embodiment

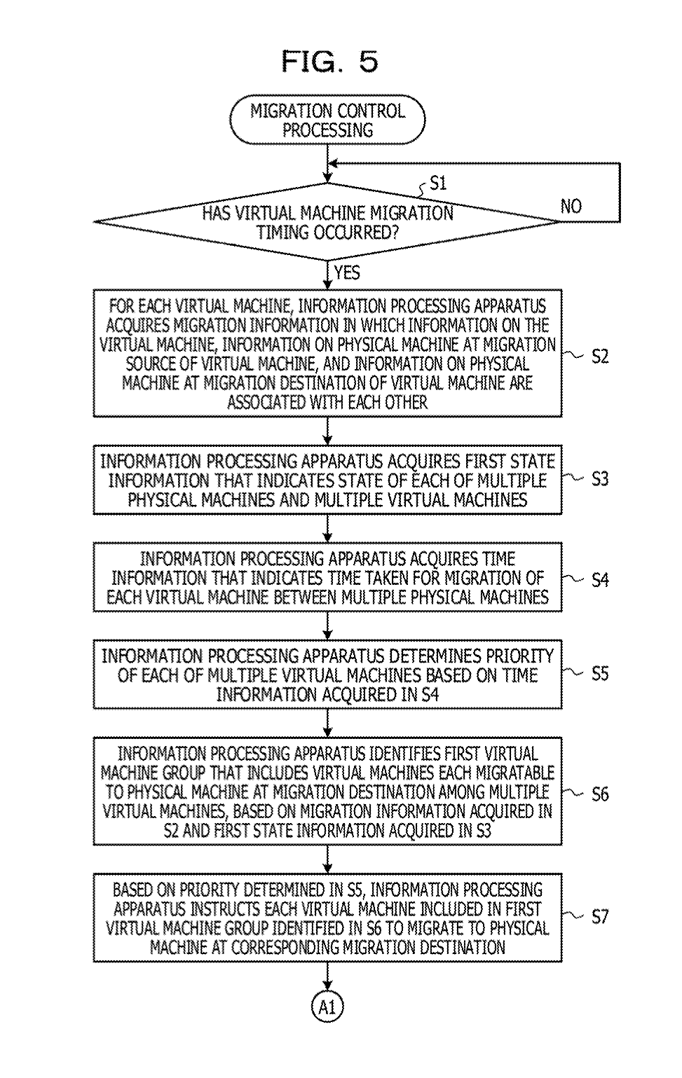

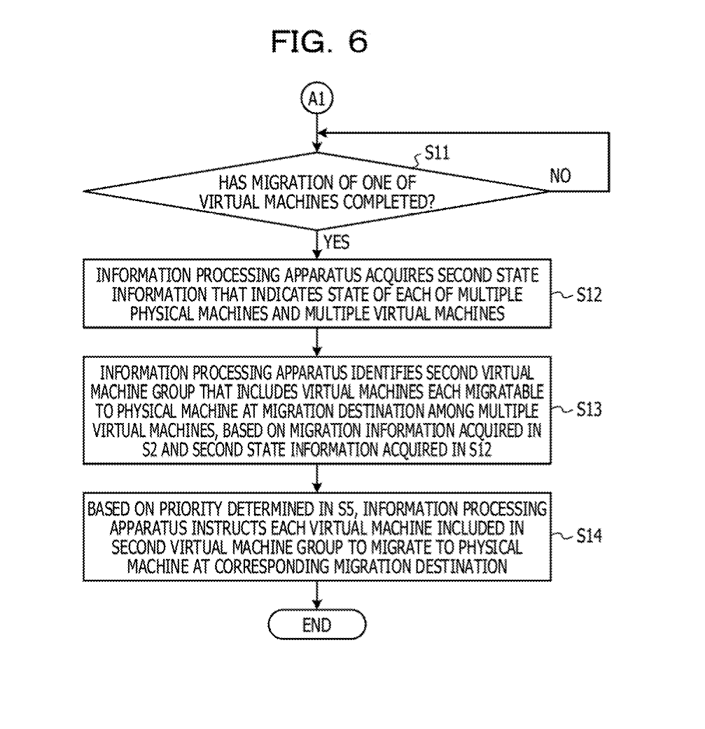

Next, the outline of a first embodiment will be described. FIGS. 5 and 6 are flowcharts for illustrating the outline of migration control processing in the first embodiment.

As illustrated in FIG. 5, the information processing apparatus 1 stays in standby until migration timing of a virtual machine 3 occurs (NO in S1). The migration timing of the virtual machine 3 may be, for instance, a timing at which an administrator determines that reallocation of the virtual machine 3 is performed. For instance, the migration timing of the virtual machine 3 may be a timing at which an administrator determines that reallocation of the virtual machine 3 is performed due to an occurrence of an event that the usage rate of a physical resource exceeds a predetermined threshold in a physical machine 2 in which the virtual machine 3 is allocated.

When migration timing of a virtual machine 3 occurs (YES in S1), for each virtual machine 3, the information processing apparatus 1 acquires the migration target information 131 in which information on the virtual machine 3, information on the physical machine 2 at a migration source of the virtual machine 3, and information on the physical machine 2 at a migration destination of the virtual machine 3 are associated with each other (S2). Also, the information processing apparatus 1 acquires the first state information 132a that indicates the state of each of multiple physical machines 2 and multiple virtual machines 3 (S3). In addition, the information processing apparatus 1 acquires the time information 131a that indicates the time taken for migration of each virtual machine 3 between the multiple physical machines 2 (S4).

Next, the information processing apparatus 1 determines the priority of each of the multiple virtual machines 3 based on the time information 131a acquired by the processing in 54 (S5). That is, when time information 131a corresponding to each virtual machine 3 indicates different information, in order perform migration of all the virtual machines 3 efficiently, it is preferable that the information processing apparatus 1 first migrate, for instance, a virtual machine 3 for which the time information 131a indicates a longer time. Thus, in the processing of S5, the information processing apparatus 1 determines a priority which serves as a determination criterion used when an order migration of the virtual machines 3 is determined.

Next, the information processing apparatus 1 identifies the first virtual machine group that includes virtual machines 3 each migratable to the physical machine 2 at a migration destination among the multiple virtual machines 3, based on the migration information 131 acquired by the processing of 52 and the first state information 132a acquired by the processing of S3 (S6). Based on the priority determined by the processing of S5, the information processing apparatus 1 instructs each virtual machine 3 included in the first virtual machine group identified by the processing of S6 to migrate to the physical machine 2 at a corresponding migration destination (S7).

In other words, when multiple migratable virtual machines 3 (virtual machines 3 included in the first virtual machine group) are present in the physical machine 2 at a migration destination, the information processing apparatus 1 refers to the priority determined by the processing of S5, and determines a virtual machine 3 to be migrated to the physical machine 2 at a migration destination, Thus, the information processing apparatus 1 is able to preferentially migrate a virtual machine 3, which produces the greatest effect on reducing the time taken for migration of all the virtual machines 1

Subsequently, as illustrated in FIG. 6, the information processing apparatus 1 stays in standby until migration of one of the virtual machines 3, which have been instructed to migrate to the physical machine 2 at a migration destination, is completed (NO in S11). When migration of one of the virtual machines 3 is completed (YES in S11), the information processing apparatus 1 acquires the second state information 132b that indicates the state of each of the multiple physical machines 2 and the multiple virtual machines 3 (S12). The information processing apparatus 1 then identifies the second virtual machine group that includes virtual machines 3 each migratable to the physical machine 2 at a migration destination among the multiple virtual machines 3, based on the migration information 131 acquired by the processing of S2 and the second state information 132b acquired by the processing of S12 (S13).

In other words, when migration of one of the virtual machines 3 is completed, available state of the physical resource of each physical machine 2 changes. Therefore, with the completion of migration of the one virtual machine 3, there is a possibility that a virtual machine 3 may occur, which is newly migratable to the physical machine 2 at a migration destination. Thus, when migration of one of the virtual machines 3 is completed, the information processing apparatus 1 acquires the state information 132 (the second state information 132b) the reflects the state after migration of the virtual machine 3 is completed, and identifies a virtual machine group (the second virtual machine group) that includes virtual machines 3 each of which has become migratable to the physical machine 2 at a migration destination.

Subsequently, based on the priority determined by the processing of S5, the information processing apparatus 1 instructs each virtual machine 3 included in the second virtual machine group identified by the processing of S12 to migrate to the physical machine 2 at a corresponding migration destination (S14). The information processing apparatus 1 then repeats the processing of S11 to S14 until migration of each of all the virtual machines 3 to the physical machine 2 at a migration destination is completed, for instance.

In this manner, the information processing apparatus 1 in this embodiment determines a priority of each virtual machine 3 based on the time information 131a that indicates the time taken for migration of each virtual machine 3 between the physical machines 2. The information processing apparatus 1 then identifies a first virtual machine group that includes virtual machines 3 each migratable to the physical machine 2 at a migration destination, based on the migration information 131 on the physical machines 2 at a migration source and a migration destination of each virtual machine 3, and the first state information 132a that indicates the state of each physical machine 2 and each virtual machine 3. In addition the information processing apparatus 1 instructs each virtual machine 3 included in the first virtual machine group to migrate to the physical machine 2 at a migration destination based on the priority of the virtual machine 3.

Subsequently, the information processing apparatus 1 identifies the second virtual machine group that includes virtual machines 3 each migratable to the physical machine 2 at a migration destination based on the migration information and the second state information 132b indicating the state of each physical machine 2 and each virtual machine 3 when migration of one of the virtual machines 3 is completed. The information processing apparatus 1 then instructs each virtual machine 3 included in the second virtual machine group to migrate to the physical machine 2 at a migration destination based on the priority of the virtual machine 3.

Thus, when multiple migratable virtual machines 3 are present in the physical machine 2 at a migration destination, the information processing apparatus 1 is able to migrate a virtual machine 3, which produces the greatest effect on reducing the time taken for migration of all the virtual machines 3. Thus, even when the times taken for migration of the virtual machines 3 are varied, it is possible for the information processing apparatus 1 to determine an order of migration that reduces the time taken for migration of all the virtual machines 3 to the physical machine 2 at a migration destination.

Also, in response to a change in available state of the physical resource of each physical machine 2, the information processing apparatus 1 is able to identify a new virtual machine 3 which has become migratable. Thus, it is possible for the information processing apparatus 1 to update selection of a virtual machine 3 as desired for instructing migration to the physical machine 2 at a migration destination. Therefore, it is possible for the information processing apparatus 1 to search for an order of migration for reallocating virtual machines 3 based on the optimal allocation of the virtual machines 3.

### Details of First Embodiment

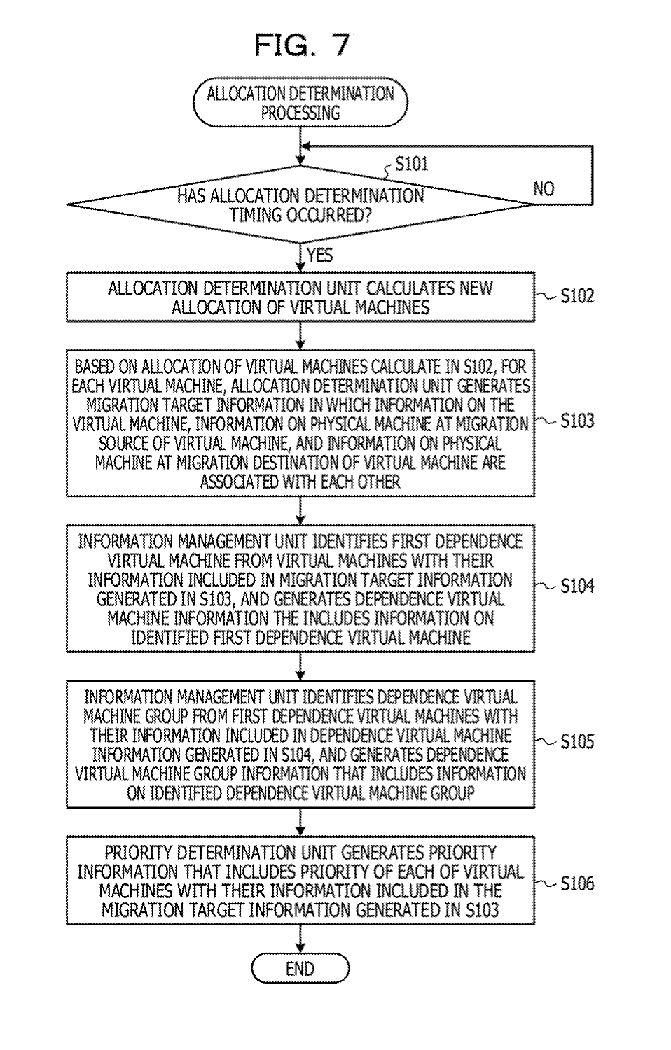

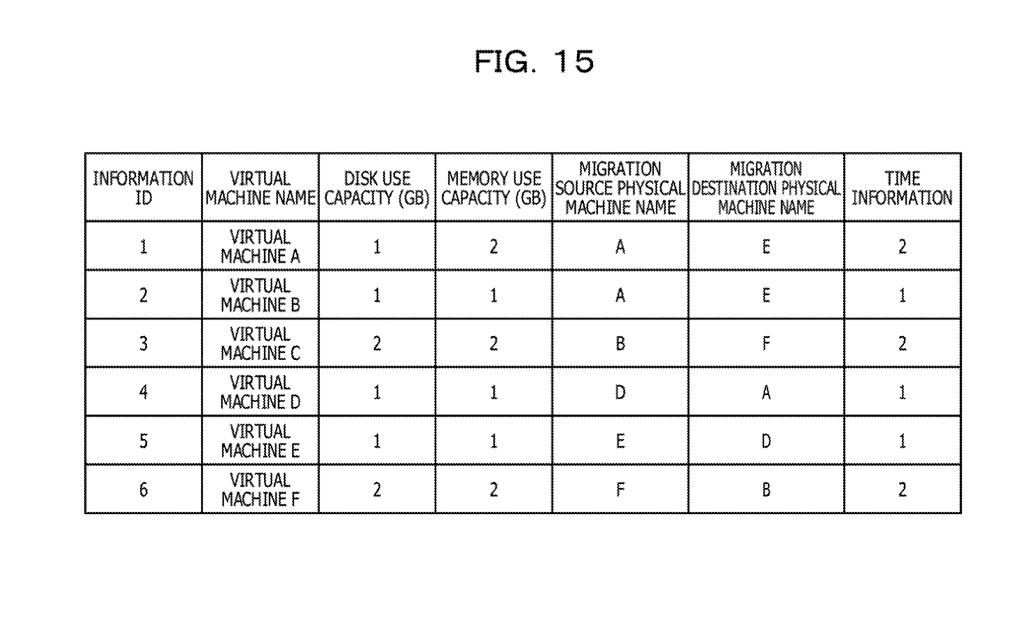

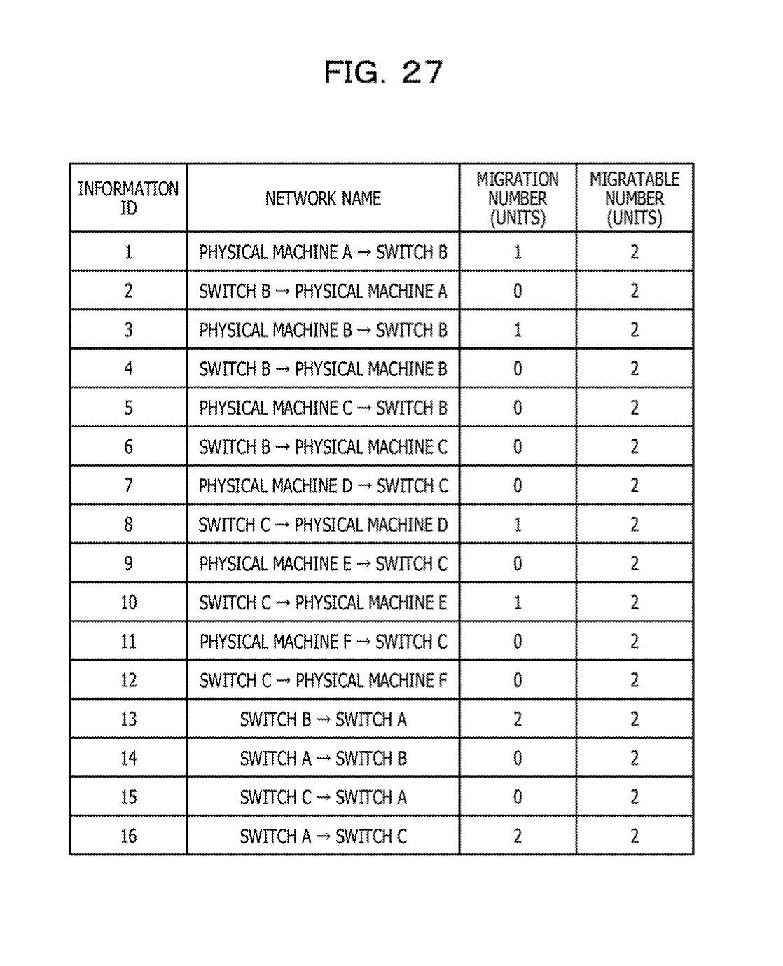

Next, the details of the first embodiment will be described. FIGS. 7, 8, 9, 10, 11, 12, 13, and 14 are flowcharts for illustrating the details of the migration control processing in the first embodiment. FIGS. 15 to 30 are a diagram illustrating the details of the migration control processing in the first embodiment. The migration control processing in FIGS. 7 to 14 will be described with reference to FIGS. 15 to 30.

### Allocation Determination Processing

First, the processing (hereinafter also referred to as allocation determination processing) for determining an optimal allocation of the virtual machines 3 will be described.

As illustrated in FIG. 7, the allocation determination unit 111 stays in standby until allocation determination timing occurs (NO in S101). The allocation determination timing may be, for instance, a timing at which an administrator determines that reallocation of the virtual machines 3 is performed. For instance, the allocation determination timing may be a timing at which an administrator determines that reallocation of the virtual machine 3 is performed due to an occurrence of an event that the usage rate of a physical resource exceeds a predetermined threshold in a physical machine 2 in which the virtual machine 3 is allocated.

When allocation determination timing occurs (YES in S101), the allocation determination unit 111 calculates (determines) a new allocation (an optimal allocation) of the virtual machines 3 (S102). The allocation determination unit 111 utilizes, for instance, mathematical programming to calculate the optimal allocation of the virtual machines 3, which allows the physical resources of the physical machines 2 to be used efficiently.

Subsequently, the information management unit 114 generates migration target information 131 based on the optimal allocation of the virtual machines 3 calculated by the processing of S102 (S103). For instance, for each virtual machine 3, the allocation determination unit 111 generates migration target information 131 in which information on the virtual machine 3, information on the physical machine 2 at a migration source of the virtual machine 3, and information on the physical machine 2 at a migration destination of the virtual machine 3 are associated with each other. The information management unit 114 then stores the generated migration target information 131 in the information storage area 130, for instance. Hereinafter, an example of the migration target information 131 will be described.

### Example of Migration Target Information

FIG. 15 is an example of the migration target information. Hereinafter, the case where reallocation of the virtual machines 3 is performed will be described with reference to arrows illustrated in FIG. 2. It is to be noted that hereinafter, the physical machines 2A, 2B, 2C, 2D, 2E, and 2F described in FIG. 2 are also denoted by the physical machines A, B, C, D, E, and F, respectively, or simply by A, B, C, D, E, and F, respectively. Also, hereinafter, the virtual machines 3A, 3B, 3C, 3D, 3E, and 3F described in FIG. 2 are also denoted by the virtual machines A, B, C, D, E, and F, respectively, or simply by B, C, D, E, and F, respectively.

The migration target information 131 illustrated in FIG. 15 has items of “information ID” that identifies each piece of information included in the migration target information 131, “virtual machine name” that indicates the name of each virtual machine 3, and “disk use capacity” that indicates the use capacity of the disk used by each virtual machine 3 for operation. The migration target information 131 illustrated in FIG. 15 further has items of “memory use capacity” that indicates the use capacity of the memory used by each virtual machine 3 for operation, and “migration source physical machine name” indicates the name of the physical machine 2 at a migration source. In addition, the migration target information 131 illustrated in FIG. 15 has items of “migration destination physical machine name” that indicates the name of the physical machine 2 at a migration destination, and “time information” that indicates the time information 131a.

For instance, in the migration target information 131 illustrated in FIG. 15, for the information with “information ID” of “1”, “virtual machine name” is set to “virtual machine A”, “disk use capacity” is set to “1 (GB)” and “memory use capacity” is set to “2 (GB)”. Also, in the migration target information 131 illustrated in FIG. 15, for the information with “information ID” of “1”, “migration source physical machine name” is set to “A”, “migration destination physical machine name” is set to “E” and “time information” is set to “2”. A description of other pieces of information included in FIG. 15 will be omitted.

Returning to FIG. 7, the information management unit 114 identifies the first dependence virtual machine from the virtual machines 3 with their information included in the migration target information 131 generated by the processing of S103. The first dependence virtual machine is a virtual machine 3 which has to be first migrated in order for each of other virtual machines 3 included in the multiple virtual machines 3 to migrate to the physical machine 2 at a migration destination. The information management unit 114 then generates dependence virtual machine information 138 which includes information on the identified first dependence virtual machine (S104). Subsequently, the information management unit 114 stores the generated dependence virtual machine information 138 in the information storage area 130, for instance. Hereinafter, an example of the dependence virtual machine information 138 will be described.

### Example of Dependence Virtual Machine Information

First, a dependence graph generated by the information management unit 114 when the dependence virtual machine information 138 is generated will be described. The dependence graph is a graph that indicates a relationship between each dependence virtual machine and a virtual machine 3 (hereinafter also referred to as a virtual machine 3 depending on the dependence virtual machine) for which whether or not the virtual machine 3 is migratable to the physical machine 2 at a migration destination changes by a migration Mate of the dependence virtual machine.

For instance, when a dependence graph is generated, the information management unit 114 generates a partial dependence graph which is dependence graph for each of the physical machines 2 included in the information processing system 10, Hereinafter, an example of a partial dependence graph will be described. It is to be noted that hereinafter, the virtual machines 3A, 3B, 3C, 3D, 3E, and 3F are also denoted by VM-A, VM-B, VM-C, VM-D, VM-E, and VM-F, respectively. Also, hereinafter, the partial dependence graphs of the physical machines 2A, 2B, 2C, 2D, 2E, and 2F are also denoted by the partial dependence graphs A, B, C, D, E, and F, respectively.

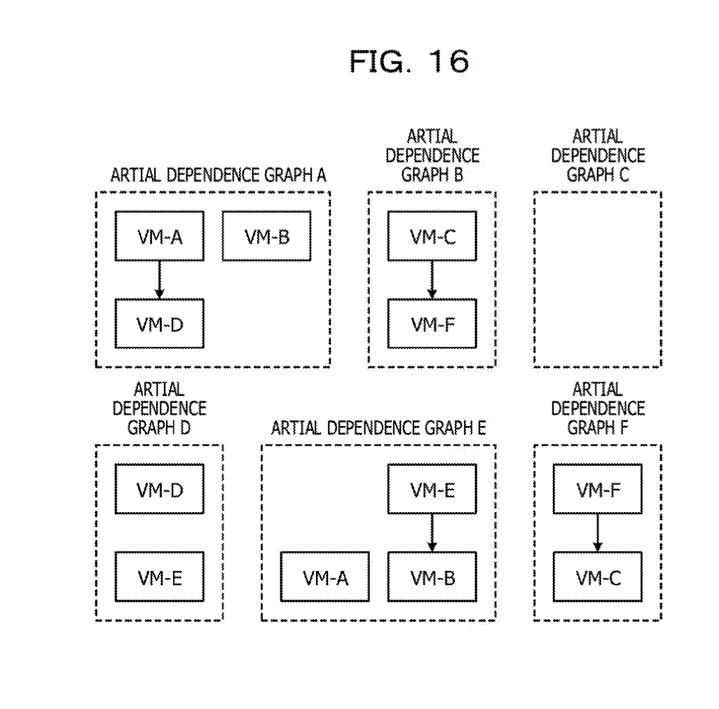

FIG. 16 is an example of a partial dependence graph. The partial dependence graph illustrated in FIG. 16_{>}indicates a dependency at the time when each virtual machine 3 is migrated as illustrated in FIG. 2.

In the example illustrated in FIG. 2, the virtual machine 3A and the virtual machine 36 are allocated in the physical machine 2A. In the physical machine 2E which is the physical machine 2 of the migration destination of the virtual machine 3A and the virtual machine 38, available capacity in the disk of is “1 (GB)”, and available capacity in the memory is “2 (GB)”. Also, in the virtual machine 3A, the use capacity in the disk is “1 (GB)” and the use capacity in the memory is “2 (GB)”, and in the virtual machine 3B, the use capacity in the disk is “1 (GB)” and the use capacity in the memory is “1 (GB)”. Thus, in the example illustrated in FIG. 2, only one virtual machine 3 of the virtual machine 3A and the virtual machines 3B is migratable to the physical machine 2E. In order to migrate both the virtual machine 3A and the virtual machine 38 to the physical machine 2E, the virtual machine 3E allocated in the physical machine 2E has to be first migrated to the physical machine 2D which is the physical machine 2 of the migration destination. In other words, in this case, one unit of the virtual machine 3A and the virtual machine 38 is dependent on the virtual machine 3E.

Thus, as illustrated in the partial dependence graph E of FIG. 16, the information management unit 114 sets VM-E in an upper portion of the partial dependence graph E, which indicates the virtual machine 3 allocated in each physical machine 2, for instance. Also, the information management unit 114 sets VM-A and VM-B in a lower portion which indicates the virtual machine 3 allocated in each physical machine 2 after migration of the virtual machine 3 is performed. The information management unit 114 then sets an arrow (arrow extending from VM-E to VM-B) that indicates, for instance, VM-B, which is one virtual' machine 3 of VM-A and VM-B, is dependent on VM-E. It is to be noted that only one virtual machine 3 of VM-A and VM-B has a dependency to VM-E, Thus, in the example illustrated in FIG. 16, the information management unit 114 does not set an arrow extending from VM-E to VM-A.

Also, in the example illustrated in FIG. 2, the virtual machine 3E is allocated in the physical machine 2E. In the physical machine 2D which is the physical machine 2 of the migration destination of the virtual machine 3E, available capacity in the disk of is “3 (GB)”, and available capacity in the memory is “3 (GB)”. Also, in the virtual machine 3E, the use capacity in the disk is “1 (GB)” and the use capacity in the memory is “1 (GB)”. Therefore, in the example illustrated in FIG. 2, the virtual machine 3E is migratable to the physical machine 2 without having to wait for migration of another virtual machines 3. In other words, in this case, the virtual machine 3E does not have a dependency to another virtual machines 3.

Thus, as illustrated in the partial dependence graph l of FIG. 16, the information management unit 114 sets VM-D in an upper portion and sets VM-E in a lower portion. The information management unit 114 does not set an arrow extending from VM-D to VM-E. A description of other partial dependence graphs illustrated in FIG. 16 will be omitted. Hereinafter an example of generating a dependence graph using the partial dependence graphs described in FIG. 16 will be described.

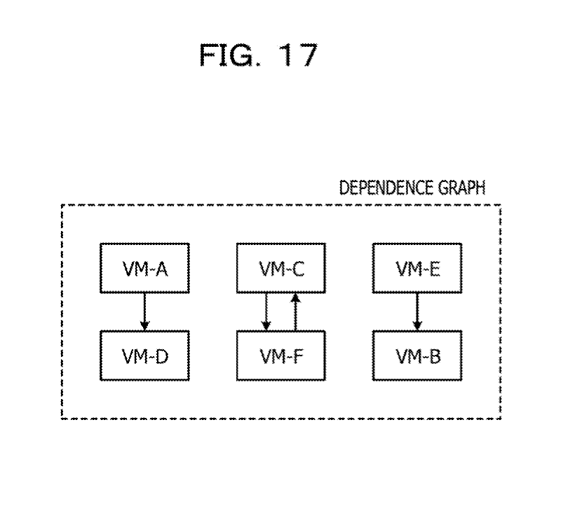

FIG. 17 is an example of a dependence graph. As illustrated in FIG. 17, the information management unit 114 generates a dependence graph by combining the arrows included in some of the partial dependence graphs described in FIG. 16, Specifically, as illustrated in FIG. 17, the information management unit 114 sets one for each virtual machine 3, and generates a dependence graph by setting the arrows included in some of the partial dependence graphs described in FIG. 16. It is to be noted that hereinafter multiple virtual machines 3 linked by an arrow among the virtual machine 3 included in a dependence graph are also referred to as a linked component.

For instance, in the dependence graph illustrated in FIG. 17, VM-D is dependent on VM-A, and VM-B is dependent on VM-E. Also, in the dependence graph illustrated in FIG. 17, VM-C is dependent on VM-F, and VM-F is dependent on VF-C. In other words, in the dependence graph illustrated in FIG. 17, VM-C and VM-F have a relationship (hereinafter also referred to as circulation of dependency) in which one virtual machine 3 of VM-C and VM-F is a dependence virtual machine of another virtual machines 3, Thus, unless at least one virtual machine 3 of VM-C and VM-F migrates (hereinafter also referred to as retreat) to a physical machine 2 other than the currently allocated physical machine 2 (the physical machine 2 at a migration source) and the physical machine 2 at a migration destination, it is not possible to migrate to the physical machine 2 at each migration destination. Therefore, in order to properly complete the migration control processing, at least one virtual machine 3 of VM-C and VM-F is to be retreated to a physical machine 2 other than the currently allocated physical machine 2 and the physical machine 2 at a migration destination.

It is to be noted that hereinafter the migration control processing performed based on the dependence graph described in FIG. 17 will be described. However, the migration control processing may be performed based on another dependence graph (for instance, a dependence graph when the virtual machine 3A is dependent on the virtual machine 3E). In this case, for instance, the information processing apparatus 1 may adopt a result from the results (an order of migration of the virtual machines 3 to the physical machine 2 at each migration destination) obtained by the migration control processing each performed, the result providing the shortest total time taken for migration of all the virtual machines 3.

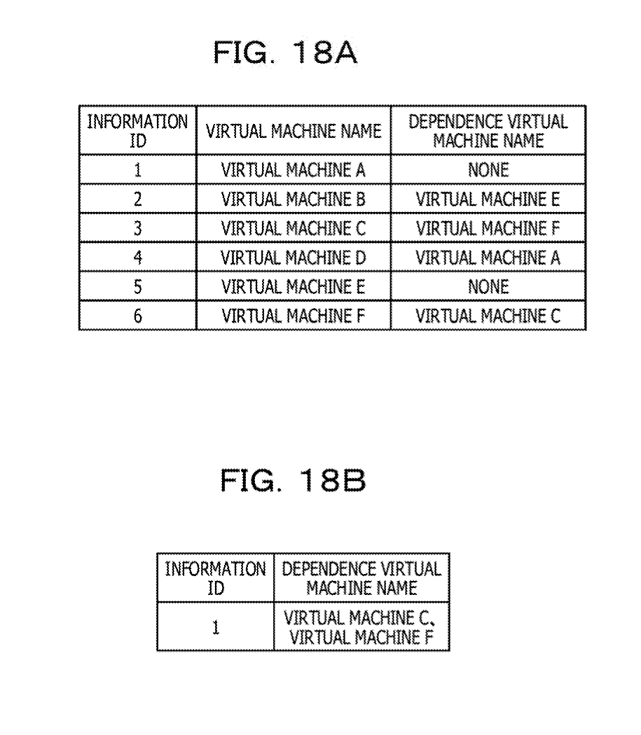

Next, an example of the dependence virtual machine information 138 will be described. FIG. 18A is an example of the dependence virtual machine information 138. FIG. 18B is an example of the dependence virtual machine group information.

The dependence virtual machine information 138 illustrated in FIG. 18A has items of “information ID” that identifies each piece of information included in the dependence virtual machine information 138, and “virtual machine name” that identifies each virtual machine 3. The dependence virtual machine information 138 illustrated in FIG. 18A has an item “dependence virtual machine name” that identifies a dependence virtual machine on which each virtual machine 3 is dependent.

For instance, the detail of the dependence virtual machine information 138 illustrated in FIG. 18A corresponds to the detail of the dependence graph described in FIG. 17. In the dependence virtual machine information 138 illustrated in FIG. 18A, for the information (information with “information ID” of “2”) with “virtual machine name” of “virtual machine B”, “dependence virtual machine name” is set to “virtual machine E”. In the dependence virtual machine information 138 illustrated in FIG. 18A, for the information (information with “information ID” of “3”) with “virtual machine name” of “virtual machine C”, “dependence virtual machine name” is set to “virtual machine F”. On the other hand, in the dependence virtual machine information 138 illustrated in FIG. 18A, for the information (information with “information ID” of “1”) with “virtual machine name” of “virtual machine A”, “dependence virtual machine name” is set to “none”. A description of other pieces of information included in FIG. 18A will be omitted.

Returning to FIG. 7, for each of the first dependence virtual machines with their information included in the dependence virtual machine information 138 generated by the processing of S104, the information management unit 114 identifies a dependence virtual machine group including two or more virtual machines 3 that have a circulated relationship between the first dependence virtual machine and a virtual machine 3 which becomes migratable to the physical machine 2 at a migration destination by prior migration of the first dependence virtual machine. The information management unit 114 then generates the dependence virtual machine group information 139 which includes the information on the identified dependence virtual machine group (S105). Subsequently, the information management unit 114 stores the generated dependence virtual machine group information 139 in the information storage area 130, for instance. Hereinafter, an example of the dependence virtual machine group information 139 will be described.

### Example of Dependence Virtual Machine Group Information

The dependence virtual machine group information 139 illustrated in FIG. 18B has items of “information ID” that identifies each piece of information included in the dependence virtual machine group information 139, and “dependence virtual machine name” that identifies a dependence virtual machine included in each dependence virtual machine group.

In the dependence graph described in FIG. 17 and the dependence virtual machine information 138 described in FIG. 18A, the dependence virtual machines having a circulated dependency are the virtual machine 3C and the virtual machine 3F. Thus, the information management unit 114 identifies the virtual machine 3C and the virtual machine 3F as the dependence virtual machines forming a dependence virtual machine group. Thus, as illustrated in the dependence virtual machine group information 139 in FIG. 18B, the information management unit 114 sets “dependence virtual machine name to “virtual machine C, virtual machine F”” for the information with “information ID” of “1”.

This allows the information management unit 114 to manage the dependence virtual machine group including a dependence virtual machine which has to temporarily retreat to a physical machine 2 other than the physical machine 2 at a migration destination in order to complete the migration control processing.

Returning to FIG. 7, the priority determination unit 113 generates priority information 133 including the priority of each of the virtual machines 3 with their information included in the migration target information 131 generated by the processing of S103 (S106). The priority determination unit 113 then stores the generated priority information 133 in the information storage area 130, for instance. Hereinafter, the details of the processing of S106 will be described.

### Details of Processing of S106

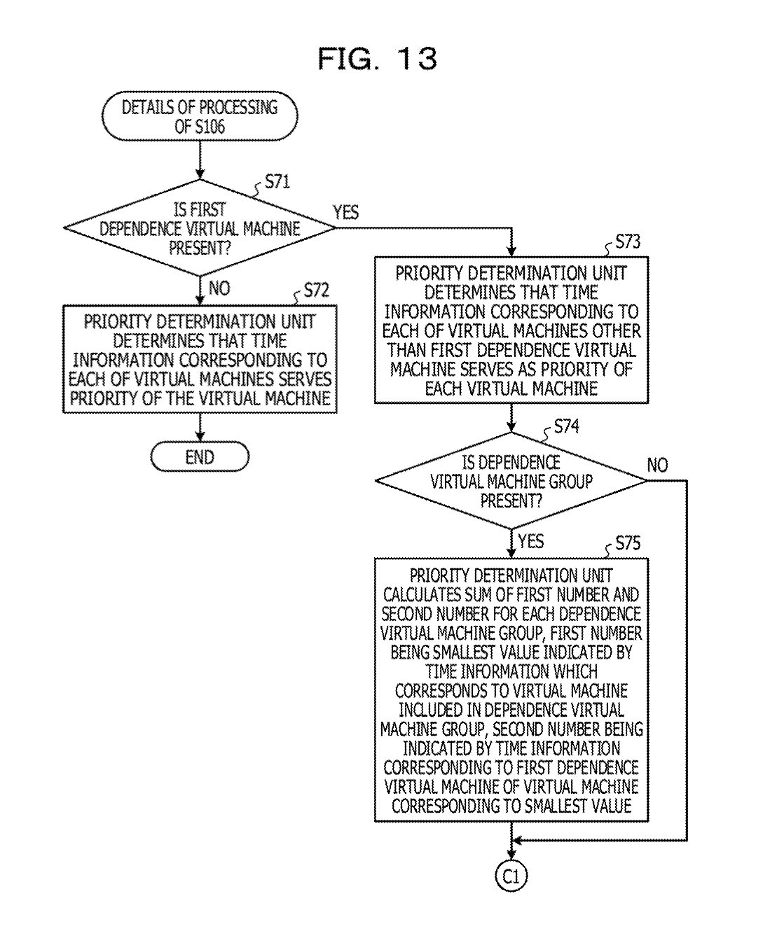

As illustrated in FIG. 13, the priority determination unit 113 determines whether or not the first dependence virtual machine is present in multiple virtual machines 3 (S71). The priority determination unit 113 refers to, for instance, the dependence virtual machine information 138 stored in the information storage area 130, and determines whether or not the first dependence virtual machine is present.

When it is determined that the first dependence virtual machine is present (YES in S71), the priority determination unit 113 determines that time information 131a corresponding to each of the virtual machines 3 other than the first dependence virtual machine serves as the priority of the virtual machine 3 (S73). On the other hand, when it is determined that the first dependence virtual machine is not present (NO in S71), the priority determination unit 113 determines that time information 131a corresponding to each of the virtual machines 3 serves as the priority of the virtual machine 3, and completes the processing of S106 (S72).

For instance, in the dependence virtual machine information 138 described in FIG. 18A, “dependence virtual machine name” is set with information: “virtual machine A”, “virtual machine C”, “virtual machine E”, and “virtual machine F”. Thus, the priority determination unit 113 identifies the virtual machines 3A, 3C, 3E and 3F as the first dependence virtual machine (YES in S74 The priority determination unit 113 then identifies the virtual machines 3B and 3D as the virtual machines 3 other than the first dependence virtual machine.

Subsequently, the priority determination unit 113 refers to the migration target information 131 described in FIG. 15, and identifies “1” as the information set for “time information” in each information with “virtual machine name” of “virtual machine B” and “virtual machine D”. The priority determination unit 113 then determines that the priority of each of the virtual machine 3B and the virtual machine 3D is “1” (S73).

After the processing of S73, the priority determination unit 113 determines whether or not a dependence virtual machine group is present (S74). The priority determination unit 113 refers to, for instance, the dependence virtual machine group information 139 stored in the information storage area 130, and determines whether or not a dependence virtual machine group is present.

When it is determined that a dependence virtual machine group is present (YES in S74), the priority determination unit 113 calculates the sum of a first number and a second number for each dependence virtual machine group, the first number being the smallest value indicated by time information 131a which corresponds to, a virtual machine 3 included in the dependence virtual machine group, the second number being indicated by time information 131a corresponding to the first dependence virtual machine on which a virtual machine 3 corresponding to the smallest value is dependent. The priority determination unit 113 further determines that each calculated sum is the priority of the first dependence virtual machine on which a virtual machine 3 corresponding to the smallest value in the time information 131a is dependent (S75).

For instance, in the dependence virtual machine group information 139 described in FIG. 18B, the information set for “dependence virtual machine name” is “virtual machine C” and “virtual machine F” (YES in S74). The priority determination unit 113 then refers to the migration target information 131 described in FIG. 15, and identifies “2” as the information set for “time information” in each information with “virtual machine name” of “virtual machine C” and “virtual machine F” (S75).

Thus, as the smallest value indicated by time information 131 which may correspond to a virtual machine 3 included in the dependence virtual machine group, the priority determination unit 113 identifies “2” as the information set for “time information” in the information with “virtual machine name” of “virtual machine C”, for instance. Also, as the time information 131a corresponding to the first dependence virtual machine on which a virtual machine 3 corresponding to the smallest value in the time information 131a is dependent, the priority determination unit 113 identifies “2” as the information set for “time information” in the information with “virtual machine name” of “virtual machine F”, for instance. The priority determination unit 113 then determines that “4”, the sum of the identified values is the priority of the virtual machine 3F that is the first dependence virtual machine on which a virtual machine 3 corresponding to the smallest value in the time information 131a is dependent (S75).

That is, in the processing of S75, the priority determination unit 113 determines that a virtual machine 3 having a shortest time information among the virtual machines 3 included in the dependence virtual machine group retreats to a physical machine 2 other than the physical machine 2 at a migration destination. The priority determination unit 113 determines a priority under the precondition that a virtual machine 3 having a shortest time information among the virtual machines 3 included in the dependence virtual machine group is to retreat. This allows the priority determination unit 113 to determine a priority so as to reduce the time taken for retreat of a virtual machine 3.

It is to be noted that in the processing of S73, the priority determination unit 113 does not determine a priority for each virtual machine 3 included in the dependence virtual machine group but in the processing of S75, determines a priority for each virtual machine 3 included in the dependence virtual machine group. Thus, in the later-described processing of S82, the priority determination unit 113 may determine a priority for other virtual machines 3 (virtual machines 3 for which a priority has not been determined in the processing of S75) included in the dependence virtual machine group.

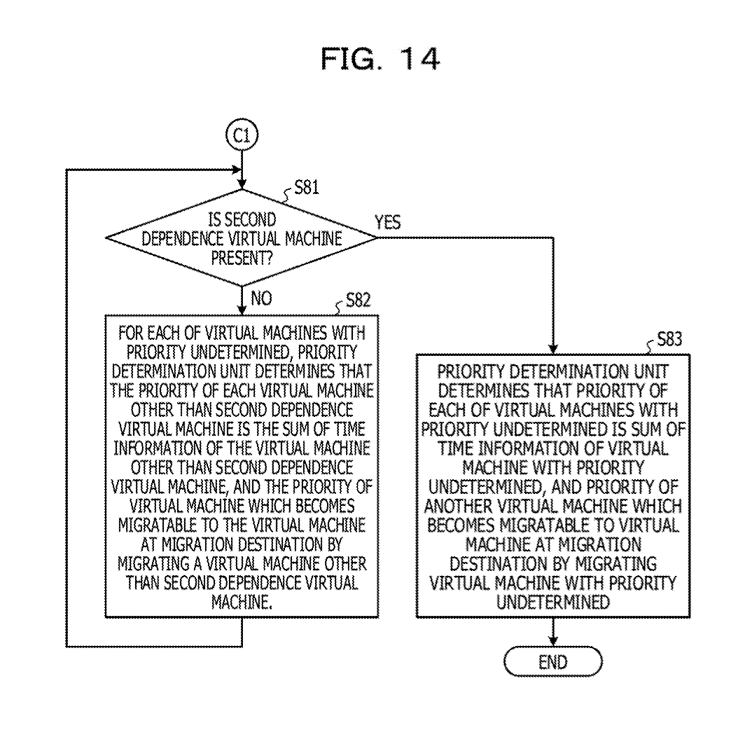

Subsequently, as illustrated in FIG. 14, the priority determination unit 113 determines whether or not the second dependence virtual machine is present in multiple virtual machines 3 (S81). The second dependence virtual machine is a virtual machine 3 which has to be first migrated in order to migrate each of the virtual machines 3 with priority undetermined to the physical machine 2 at a migration destination.

When it is determined that the second dependence virtual machine is present (YES in S81), the priority determination unit 113 identifies the time information 131a of each virtual machines 3 other than the second dependence virtual machine among the virtual machines 3 with priority undetermined. Also, in this case, for each of the virtual machines 3 with priority undetermined, the priority determination unit 113 identifies the priority of the virtual machine 3 which becomes migratable to the virtual machine 3 at a migration destination by first migrating a virtual machine 3 other than the second dependence virtual machine. The priority determination unit 113 determines that the sum of the identified values is the priority of each virtual machine 3 other than the second dependence virtual machine among the virtual machines 3 with priority undetermined (S82). Subsequently, the priority determination unit 113 performs the processing in and after S81 again.

On the other hand, when it is determined that the second dependence virtual machine is not present (NO in S81), the priority determination unit 113 identifies time information 131a corresponding to each of the virtual machines 3 with priority undetermined. In this case, the priority determination unit 113 identifies the priority of each virtual machine 3 which becomes migratable to the virtual machine 3 at a migration destination by migration of the virtual machines 3 with priority undetermined. The priority determination unit 113 then determines that the sum of the identified values is the priority of each of the virtual machines 3 with priority undetermined (S83).

For instance, in the dependence virtual machine information 138 described in FIG. 18A, the virtual machine 3 for which a priority has not been determined by the processing from S71 to S75 is the virtual machine 3 in which “virtual machine name” is set to “virtual machine A”, “virtual machine C”, and “virtual machine E”. For the information with “virtual machine name” of “virtual machine A” and “virtual machine E”, “dependence virtual machine name” is set to “none”, and for the information with “virtual machine name” of “virtual machine C”, “dependence virtual machine name” is set to “virtual machine F”.

Thus, the priority determination unit 113 identifies the virtual machine 3C as the second dependence virtual machine (YES in S81). Also, among the virtual machines 3 with priority undetermined, the priority determination unit 113 identifies the virtual machine 3 with “virtual machine name” of “virtual machine A” and “virtual machine E” as the virtual machines 3 other than the second dependence virtual machine. The priority determination unit 113 then refers to the migration target information 131 described in FIG. 15, and identifies “2” and “1” as the information set for “time information” in each information with “virtual machine name” of “virtual machine A” and “virtual machine E”.

Furthermore, the priority determination unit 113 refers to the dependence virtual machine information 138 described in FIG. 18A, and identifies the virtual machine 3 with “virtual machine name” of “virtual machine D” and “virtual machine B” as the virtual machines 3 each of which becomes migratable to the virtual machine 3 at a migration destination by prior migration of the virtual machine 3 with “virtual machine name” of “virtual machine A” and “virtual machine E”. The priority determination unit 113 then refers to the migration target information 131 described in FIG. 15, and identifies “1” as the information set for “time information” in each information with “virtual machine name” of “virtual machine D” and “virtual machine B”.

Thus, as the priority of the virtual machine 3A, the priority determination unit 113 identifies “3” which is the sum of “2” as the time information 131a on the virtual machine 3A and “1” as the priority of the virtual machine D. Also, as the priority of the virtual machine 3E, the priority determination unit 113 identifies “2” which is the sum of “1” as the time information 131a on the virtual machine 3E and “1.” as the priority of the virtual machine B. (S82).

Subsequently, the priority determination unit 113 performs the processing in and after S81 again, and identifies “6” as the priority of the virtual machine 3F, and completes the processing of S106 (NO in S81, S83). Hereinafter, an example of the priority information 133 will be described.

### Example of Priority Information

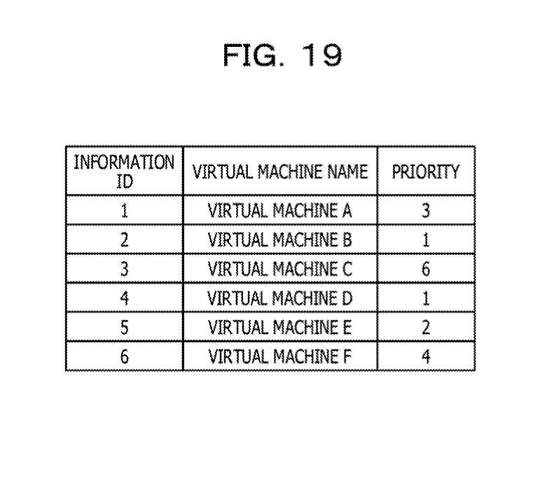

FIG. 19 is an example of the priority information. The priority information 133 illustrated in FIG. 19 has items of “information ID” that identifies each piece of information included in the priority information 133, “virtual, machine name” that identifies each virtual machine 3, and “priority” that indicates the priority of each virtual machine 3.

For instance, in the priority information 133 illustrated in FIG. 19, for the information with “information ID” of “virtual machine name” is set to “virtual machine A”, and “priority” is set to “3”. Also, in the priority information 133 illustrated in FIG. 19, for the information with “information ID” of “2”,“virtual machine name” is set “virtual machine B”, and “priority” is set to “1”. A description of other pieces of information included in FIG. 19 will be omitted.

### Details of Migration Control Processing

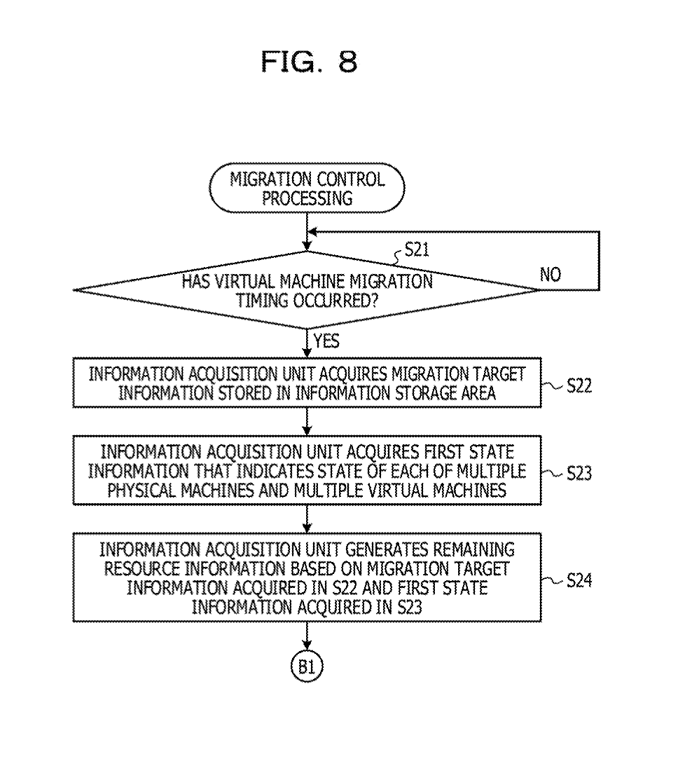

Next, the details of the migration control processing in the first embodiment will be described. FIGS. 8 to 12 are flowcharts for illustrating the details of the migration control processing in the first embodiment.

As illustrated in FIG. 8, the information acquisition unit 112 stays in standby until migration timing of the virtual machine 3 occurs (NO in S21). The migration timing of the virtual machine 3 may be after allocation determination processing is performed, for instance. When migration timing of the virtual machine 3 occurs (YES in S21), the information acquisition unit 112 acquires the migration target information 131 stored in the information storage area 130 (S22). In addition, the, information acquisition unit 112 acquires the first state information 132a that indicates the state of each of multiple physical machines 2 and multiple virtual machines 3 (S23). Hereinafter, an example of the first state information 132a will be described, It is to be noted that hereinafter the first state information 132a on each physical machine 2 is also referred to as physical machine state information 141a, and the first state information 132a on each virtual machine 3 is also referred to as virtual machine state information 142a.

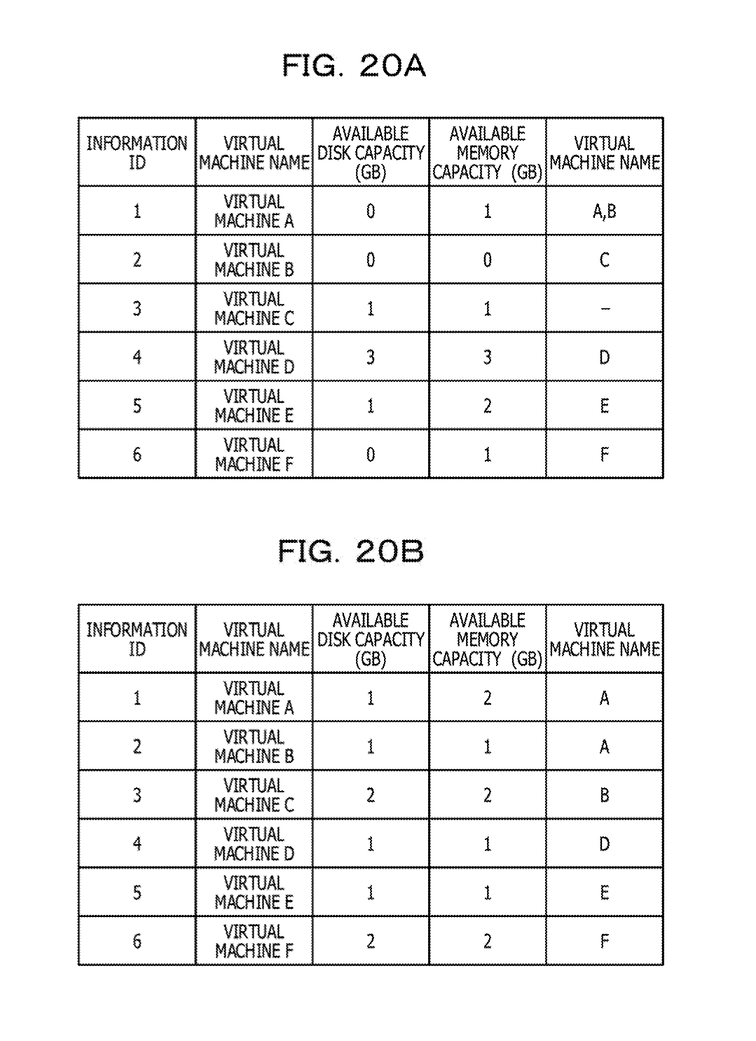

FIG. 20A is an example of the physical machine state information. FIG. 20B is an example of the virtual machine state information.

The physical machine state information 141a illustrated in FIG. 20A has items of “information ID” that identifies each piece of information included in the physical machine state information 141a, and “available disk capacity” that indicates available capacity in the disk of each physical machine 2. Also, the physical machine state information 141a illustrated in FIG. 20A has items of “available memory capacity” that indicates available capacity in the memory of each physical machine 2, and “virtual machine name” that indicates the name of each virtual machine 3 allocated in each physical machine 2.

For instance, in the physical machine state information 141a illustrated in FIG. 20A, for the information with “information ID” of “1”, “physical machine name” is set to “physical machine A”. Also, in the physical machine state information 141a illustrated in FIG. 20A, for the information with “information ID” of “1”, “available disk capacity” is set to “0 (GB)”, “available memory capacity” is set to “1 (GB)”, and “virtual machine name” is set to “B”. A description of other pieces of information included in FIG. 20A will be omitted.

The virtual machine state information 142a illustrated in FIG. 20B has items of “information ID” that identifies each piece of information included in the virtual machine state information 142a, and “disk use capacity” that indicates the use capacity of the disk for each virtual machine 3 to operate. Also, the virtual machine state information 142a illustrated in FIG. 206 has items of “memory use capacity” that indicates the use capacity of the memory for each virtual machine 3 to operate, and “physical machine name” that indicates the name of the physical machine 2 in which each virtual machine 3 is allocated

For instance, in the virtual machine state information 142a illustrated in FIG. 20B, for the information with “information ID” of “1”, “virtual machine name” is set to “virtual machine A”. Also, in the virtual machine state information 142a illustrated in FIG. 20B, for the information with “information ID” of “1”, “disk use capacity” is set to “1 (GB)”, “memory use capacity” is set to “2 (GB)”, and “physical machine name” is set to “A”. A description of other pieces of information included in FIG. 20B will be omitted.

Returning to FIG. 8, the information acquisition unit 112 generates remaining resource information 137 based on the migration target information 131 acquired by the processing of S22 and the first state information 132a acquired in S23 (S24). The information acquisition unit 112 then stores the generated remaining resource information 137 in S24 in the information storage area 130. Hereinafter, an example of the remaining resource information 137 will be described. It is to be noted that hereinafter the remaining resource information 137 on the physical resource of each physical machine 2 is also referred to as remaining physical resource information 151, and the remaining resource information 137 on the network between the physical machines 2 is also referred to as remaining network resource information 152.

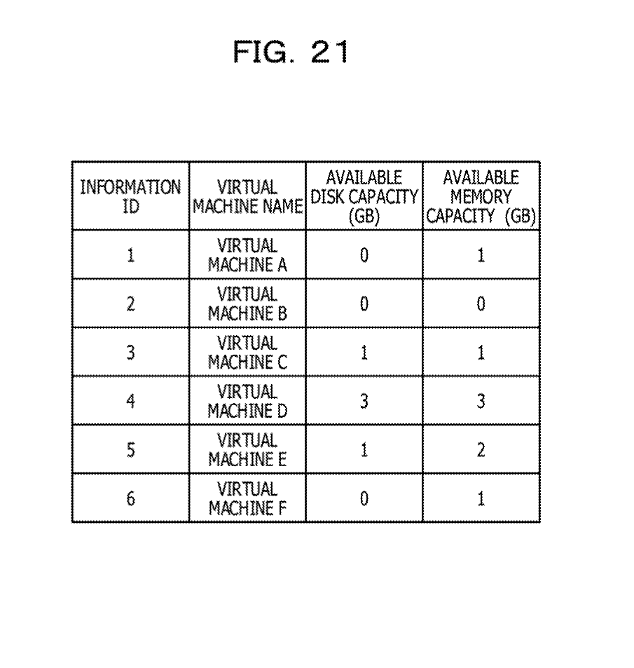

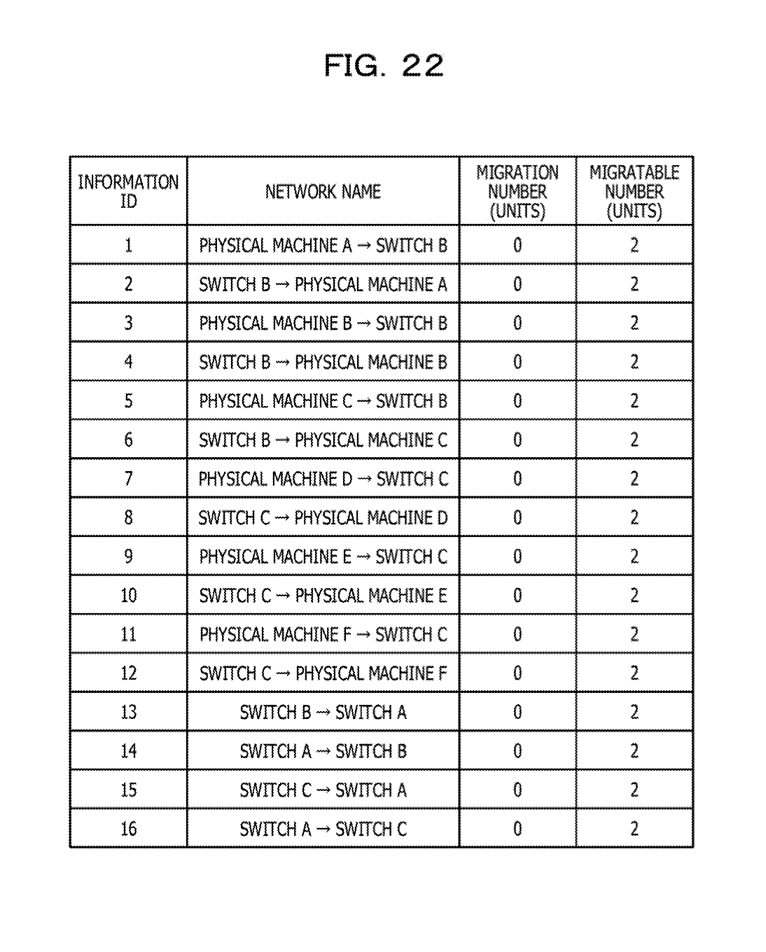

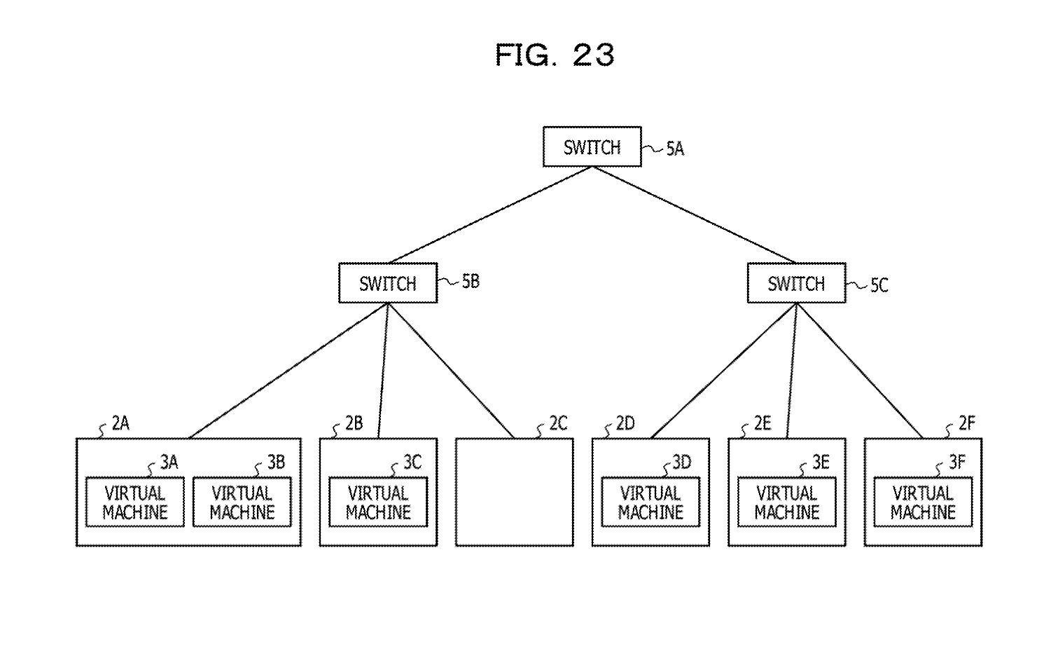

FIG. 21 is an example of the remaining physical resource information. Also, FIGS. 22, 25, and 27 are examples of the remaining network resource information. FIG. 23 is a diagram for illustrating an example network configuration between physical machines.

The remaining physical resource information 151 illustrated in FIG. 21 has items of “information ID” that identifies each piece of information included in the remaining physical resource information 151, and “physical machine name” that indicates the name of each physical machine 2. Also, the remaining physical resource information 151 illustrated in FIG. 15 has items of “available disk capacity” that indicates available capacity in the disk of each physical machine 2, and “available memory capacity” that indicates available capacity in the memory of each physical machine 2.

For instance, in the remaining physical resource information 151 illustrated in FIG. 21, for the information with “information ID” of “1”, “physical machine name” is set to “physical machine Also, in the remaining physical resource information 151 illustrated in FIG. 21, for the information with information ID” of “1”, “available disk capacity” is set to “0 (GB)”, and “available memory capacity” is set to “1 (GB)”. A description of other pieces of information included in FIG. 21 will be omitted.

Hereinafter, as illustrated in FIG. 23, a description is given under the assumption that a switch 5A is coupled to a switch 5B and a switch 5C, the switch 5B is coupled to physical machines 2A, 2B, and 2C, and the switch 5C is coupled to physical machines 2D, 2E, and 2F. Also, hereinafter the switches 5A, 5B, and 5C are also denoted by the switch A, the switch B and the switch C, respectively.

Next, the remaining network resource information 152 illustrated in FIG. 22 and others has items of “information ID” that identifies each piece of information included in the remaining network resource information 152, and “network name” that indicates the name of each network. Also, the remaining network resource information 152 illustrated in FIG. 22 and others has items of “migration number” that identifies the number of virtual machines 3 that are currently in migration using each network, and “migratable number” that indicates a maximum number (hereinafter also referred to as migratable information) of virtual machines 3 concurrently migratable in each network.

For instance, in the remaining network resource information 152 illustrated in FIG. 22, for the information with “information ID” of “1”, “network name” is set with “physical machine A->switch B” is set, which indicates that the network flows from the physical machine 2A to the switch 5B. Also, in the remaining network resource information 152 illustrated in FIG. 22, for the information with “information ID” of “1”, “migration number” is set to “0 (unit)”, and “migratable number” is set to “2 (units)”, A description of other pieces of information included in FIG. 22 will be omitted.

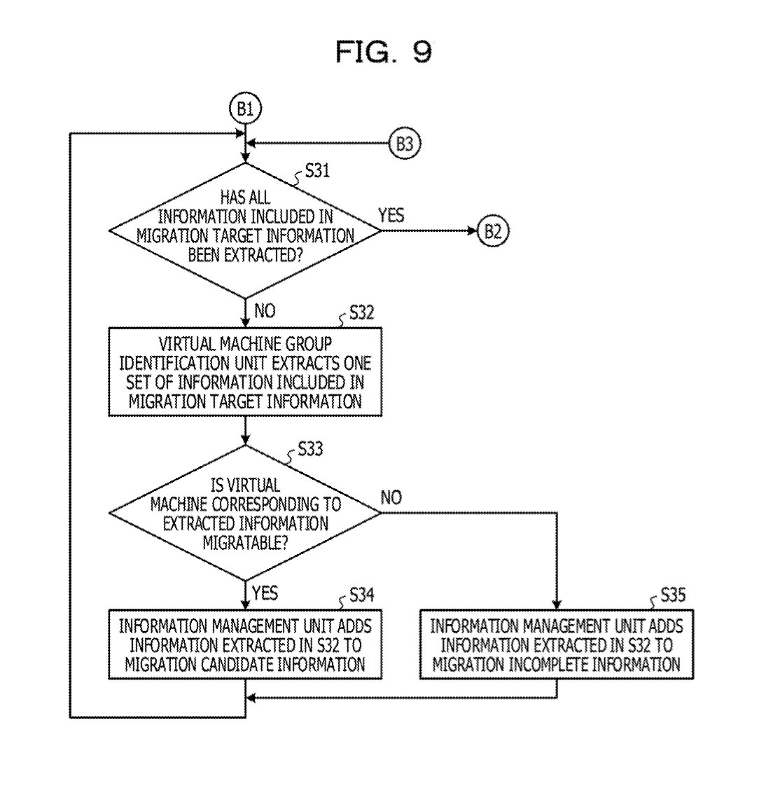

Returning to FIG. 9, the virtual machine group identification unit 115 determines whether or not all the information included in the migration target information 131 has been extracted (S31). When not all the information has been extracted (NO in S31), the virtual machine group identification unit 115 extracts one set of information included in the migration target information 131 (S32). For instance, the virtual machine group identification unit 115 extracts information in one row from the information included in the migration target information 131 described in FIG. 15.

The virtual machine group identification unit 115 then determines whether or not a virtual machine 3 corresponding to the information extracted by the processing of S32 is migratable to the physical machine 2 at a migration destination (S33). When the virtual machine 3 is migratable to the physical machine 2 at a migration destination (YES in S33), the information management unit 114 adds the information extracted by the processing of S32 to the migration candidate information 134 (S34).

On the other hand, when the virtual machine 3 corresponding to the information extracted by the processing of S32 is not migratable to the physical machine 2 at a migration destination (NO in S33), the information management unit 114 adds the information extracted by the processing of S32 to the migration incomplete information 136 (S35). Hereinafter, an example of each of the migration candidate information 134, the migration determination information 135, and the migration incomplete information 136 will be described.

### Example (1) of Migration State Information

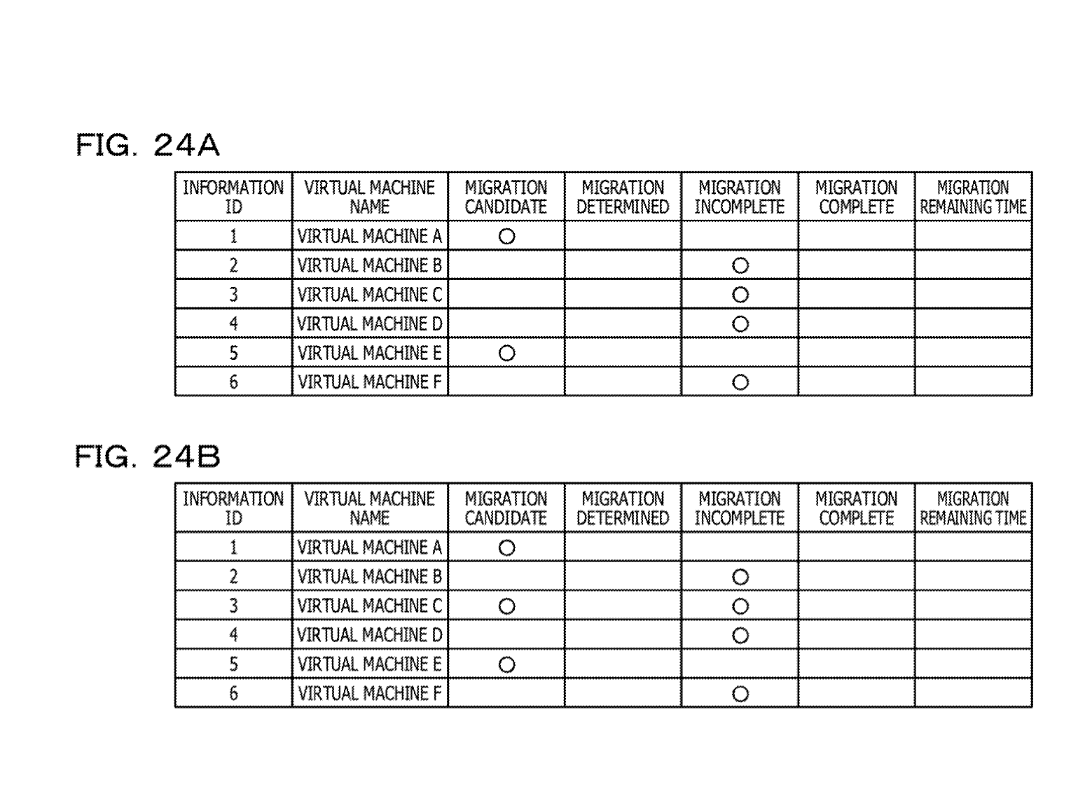

FIGS. 24A, 24B, 26A, 26B, 28A, 28B, 29A, 29B, 30A, and 30B are examples of the migration candidate information, the migration determination information, and the migration incomplete information. It is to be noted hereinafter, the migration candidate information 134, the migration determination information 135, and the migration incomplete information 136 are also collectively referred to as migration state information.

The migration state information illustrated in FIG. 24 and others has items of “information ID” that identifies each piece of information included in the migration state information, “virtual machine name” that indicates the name of each virtual machine 3, “migration candidate” which is set with information corresponding to the migration candidate information 134, and “migration determined” which is set with information corresponding to the migration determination information 135. Also, the migration state information illustrated in FIG. 24 and others has items of “migration incomplete” which is set with information corresponding to the migration incomplete information 136, and “migration completed” which is set with information that identifies a virtual machine 3 which has completely migrated to the physical machine 2 at a migration destination, Furthermore, the migration state information illustrated in FIG. 24 and others has an item of “migration remaining time” which is set with the remaining time taken for completing migration of a virtual machine 3.

For instance, the information management unit 114 refers to the dependence virtual machine information 138 described in FIG. 18A in the processing of S33, and identifies “virtual machine A” and “virtual machine E” as the information set for “virtual machine name” in the information for which “dependence virtual machine name” is set to “none”. In other words, the information management unit 114 identifies “virtual machine 3A” and “virtual machine 3E” as the virtual machines 3 which are not dependent on other virtual machines 3.

Thus, for instance, as illustrated in FIG. 24A, the information management unit 114 sets “O” in “migration candidate” for the information with “virtual machine name” of “virtual machine A” and “virtual machine E” (YES in S33, S34). For instance, as illustrated in FIG, 24A, the information management unit 114 then sets “O” in “migration incomplete” for the information with “virtual machine name” of “virtual machine B”, “virtual machine C”, “virtual machine D” and “virtual machine F” (NO in S33, S35).

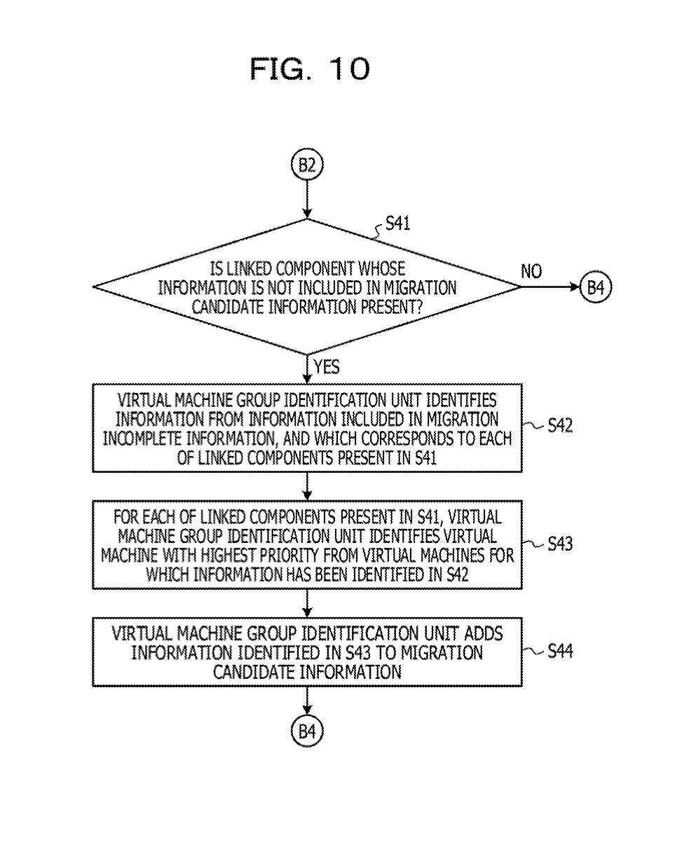

Returning to FIG. 9, when it is determined that all the information included in the migration target information 131 has been extracted (YES in S31), as illustrated in FIG. 10, the virtual machine group identification unit 115 determines whether or not a linked component, for which information is not included in the migration candidate information 134, is present (S41). When it is determined that a linked component, for which information is not included in the migration candidate information 134, is present (YES in S41), the virtual machine group identification unit 115 identifies information which corresponds to each of linked components found to be present in the processing of S41, from the information included in the migration incomplete information 136 (S42). In addition, for each of linked components found to be present in the processing of S41, the virtual machine group identification unit 115 identifies a virtual machine 3 with a highest priority from the virtual machines 3 for which information has been identified by the processing of S42 (S43). Subsequently, the virtual machine group identification unit 115 adds the information identified by the processing of S43 to the migration candidate information 134 (S44).

For instance, the dependence graph described in FIG. 17 includes the linked component (hereinafter also referred to as linked component A) including the virtual machine 3A and the virtual machine 3D, the linked component (hereinafter also referred to as linked component B) including the virtual machine 3C and the virtual machine 3F, and the linked component (hereinafter also referred to as linked component C) including the virtual machine 36 and the virtual machine 3E. Among the linked components, the linked component B does not include the virtual machine 3A or the virtual machine 3E (the virtual machines 3 for which information has been added to the migration candidate information 134 in the processing of S34).

Thus, the virtual machine group identification unit 115 refers to the priority information 133 described in FIG. 19 in the processing of 543, and identifies a virtual machine 3 having a higher priority between the virtual machine 3C and the virtual machine 3F, that is, the virtual machine 3C (S43). As illustrated in FIG. 24B, the virtual machine group identification unit 115 moves “O” set for “migration incomplete” of the information with “virtual machine name” of “virtual machine C” to “migration candidate” (S44). Consequently, the virtual machine group identification unit 115 performs the processing in S31 to S44, thereby making it possible to identify virtual machines 3 (the first virtual machine group) which are migratable to the physical machine 2 at a migration destination or the physical machine 2 at a retreat destination.

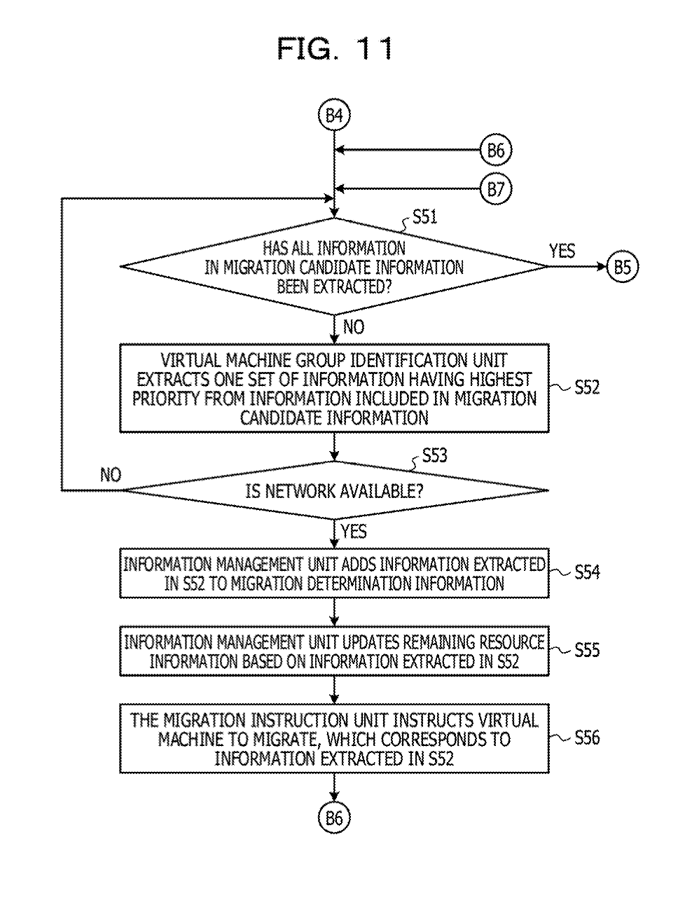

After the processing of S44 or when it is determined that a linked component, for which information is not included in the migration candidate information 134, is not present (NO in S41), as illustrated in FIG. 11, the virtual machine group identification unit 115 determines whether or not all the information included in the migration candidate information 134 has been extracted (S51). When not all the information has been extracted (YES in S51), the virtual machine group identification unit 115 extracts one set of information having a highest priority from the information included in the migration candidate information 134 (S52).

For instance, in the migration state information described in FIG. 24B, for the information with “O” set for “migration candidate”, “virtual machine name” is set with information: “virtual machine A”, “virtual machine C”, and “virtual machine E”. In the priority information 133 described in FIG. 19, for the information with “virtual machine name” set to “virtual machine A”, “virtual machine C”, and “virtual machine E”, “priority” is set to “3”, “6”, and “2”, respectively. Thus, in this case the virtual machine group identification unit 115 extracts information with “virtual machine name” of “virtual machine C” from the migration candidate information 134 (S52).

Subsequently, the virtual machine group identification unit 115 determines whether or a network used for migrating a virtual machine 3 corresponding to the information extracted in the processing of S52 is available (S53). When it is determined that the network is not available (NO in S53), the information management unit 114 performs the processing in and after S51 again. On the other hand, when it is determined that the network is available (YES in S53), the information management unit 114 performs the processing in and after S54.

For instance, when the physical machine 2 at a retreat destination of the virtual machine 3C is the physical machine 2D, the virtual machine 3C has to retreat from the currently operating physical machine 2B to the physical machine 2D. Specifically, in this case, as illustrated in FIG. 23, the virtual machine 3C has to go through the network flowing from the physical machine 2B to the switch 5B, the network flowing from the switch 5B to the switch 5A, the network flowing from the switch 5A to the switch 5C and the network flowing from the switch 5C to the physical machine 2D.

Thus, the information management unit 114 refers to the remaining network resource information 152 described in FIG. 22, and verifies that for the information with “network name” of “physical machine B->switch B”, “switch B->switch A”, “switch A->switch C”, and “switch C->physical machine D”, the value set for “migration number” is less than the value set for “migratable number”. In this case, the information management unit 114 determines that each network, which has to be used for migration of the virtual machine 3C, is available (YES in S53).

Subsequently, when it is determined that each network is available (YES in S53), the information management unit 114 adds the information extracted by the processing of S52 to the migration determination information 135 (S54). In this case, the information management unit 114 updates the remaining resource information 137 based on the information extracted by the processing of S52 (S55). Furthermore, in this case, the migration instruction unit 116 instructs a virtual machine 3, to migrate, which corresponds to the information extracted by the processing of S52 (S56).

The information management unit 114 and the migration instruction unit 116 repeatedly performs the processing in S52 to S56 until extraction of all the information included in the migration candidate information 134 is completed. Subsequently, when extraction of all the information included in the migration candidate information 134 is completed (YES in S51), the information management unit 114 performs the processing in and after S61.

For instance, in the migration state information described in FIG. 24B, for the information with “migration candidate” set to “O”, “virtual machine name” is set with information: “virtual machine A”, “virtual machine C”, and “virtual machine E”. Thus, the information management unit 114 performs the processing in S52 to S56 for each of the virtual machine 3A, the virtual machine 3C, and the virtual machine 3E. Hereinafter, an example of the remaining network resource information 152 when the processing in S52 to S56 is performed for the virtual machine 3A, the virtual machine 3C, and the virtual machine 3E will be described.

### Example of Remaining Network Resource Information

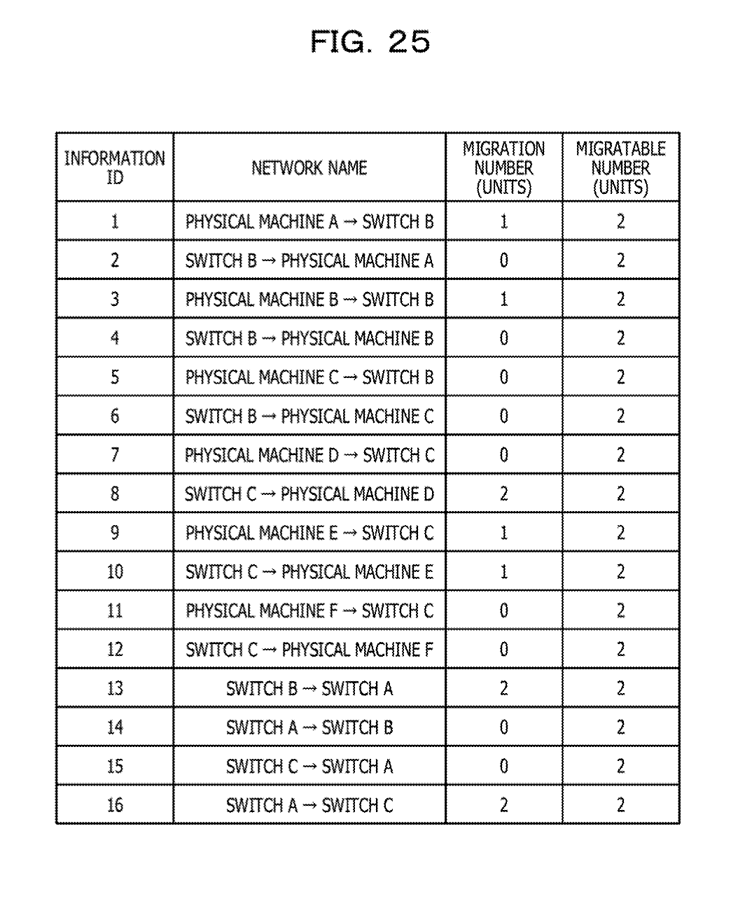

FIG. 25 is an example of remaining network resource information. In this example, the remaining network resource information 152 when the processing in S52 to S56 is performed for the virtual machine 3A, the virtual machine 3C, and the virtual machine 3E is illustrated.

As illustrated in FIG. 25, when the processing in S52 to S56 for the virtual machine 3C is performed, the information management unit 114 adds “1” to the value set for “migration number” of the information with “network name” of “physical machine B->switch B”, “switch B->switch A”, “switch A->switch C”, and “switch C->physical machine ID”. Also, when the processing in S52 to S56 for the virtual machine 3A is performed, the information management unit 114 adds “1” to the value set for “migration number” of the information with “network name” of “physical machine A->switch B”, “switch B->switch A” “switch A->switch C”, and “switch C->physical machine E”. In addition, when the processing in S52 to S56 for the virtual machine 3E is performed, the information management unit 114 adds “1” to the value set for “migration number” of the information with “network name” of “physical machine E->switch C”, and “switch C->physical machine D”.

### Example (2) of Migration State Information

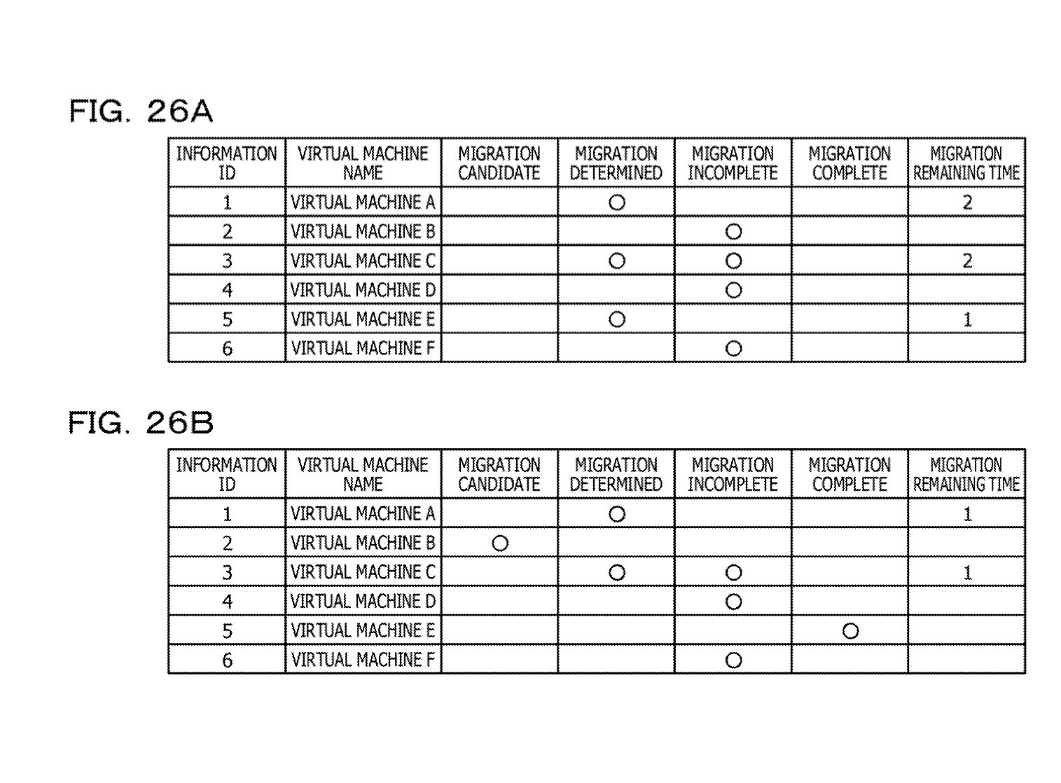

Next, an example of the migration state information when the processing in S52 to S56 is performed for the virtual machine 3A, the virtual machine 3C, and the virtual machine 3E will be described. FIG. 26A illustrates the migration state information when the processing in S52 to S56 is performed for the virtual machine 3A, virtual machine 3C, and virtual machine 3E.

When the migration state information illustrated in FIG. 26A is compared with the migration state information described in FIG. 24B, for the information with “virtual machine name” of “virtual machine A”, “virtual machine C”, and “virtual machine E”, “O” set for “migration candidate” has been moved to “migration determined”. In other words, the migration state information illustrated in FIG. 26A indicates that the virtual machine 3A, the virtual machine 3C, and the virtual machine 3E, which are migratable to the physical machine 2 at a migration destination or the physical machine 2 at a retreat destination, have actually migrated. Also, in the migration state information illustrated in FIG. 26A, “migration determined” of the information on each virtual machine 3 is set to “O”, and accordingly “migration remaining time” in the information on each virtual machine 3 is set to “2”, “2”, and “1” which are the remaining time (time information 131a) taken for migration of each virtual machine 3.

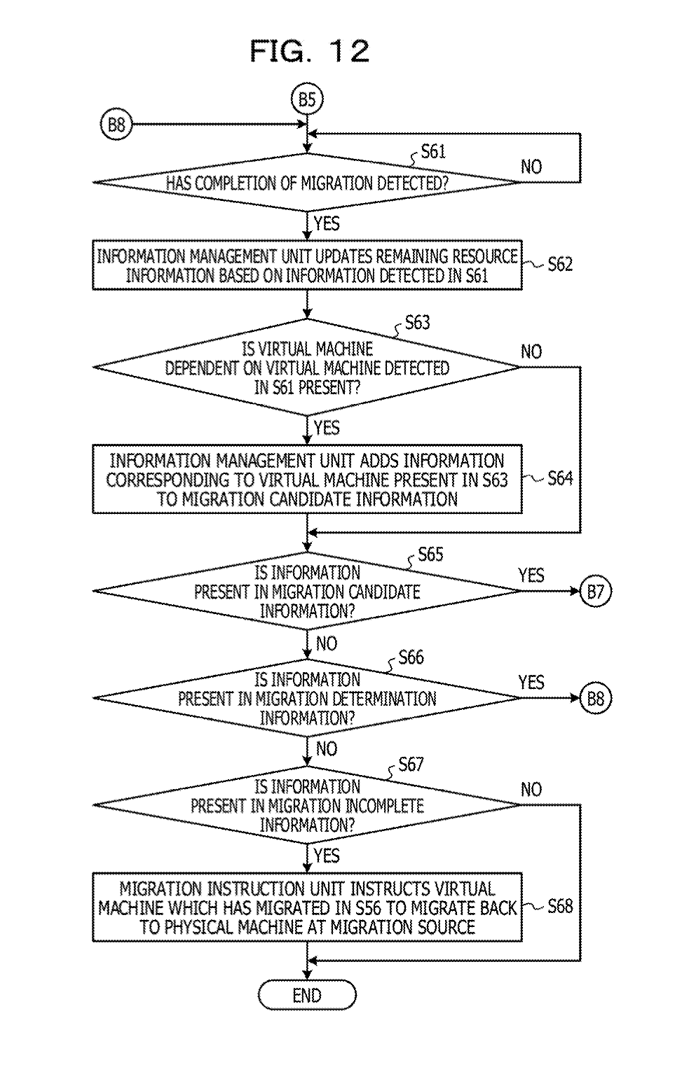

Returning to FIG. 11, when extraction of all the information included in the migration candidate information 134 is completed (YES in S51), as illustrated in FIG. 12, the information management unit 114 stays in standby until completion of migration of one of virtual machines 3 being migrated is detected (NO in S61).

When completion of migration of one of virtual machines 3 is detected (YES in S61), the information management unit 114 updates the remaining resource information 137 based on the information detected by the processing of S61 (S62). In other words, the physical resource of the physical machine 2 and the network resource between physical machines 2 are released after completion of migration of the virtual machine 3. Thus, in the processing of S62, the information management unit 114 updates information on the physical resource and the network used by the virtual machine 3 for which information is detected by the processing of S61, the information on the physical resource and the network being part of the remaining physical resource information 151 and the remaining network resource information 152.

Subsequently, the information management unit 114 determines whether or not a dependence virtual machine, which is dependent on the virtual machine 3 detected by the processing of S61, is present (S63). In other words, the information management unit 114 determines whether or not a newly migratable virtual machine 3 has occurred after completion of migration of the virtual machine 3.

When it is determined that a dependence virtual machine is present, which is dependent on the virtual machine 3 detected by the processing of S61 (YES in S63), the information management unit 114 adds information corresponding to the virtual machine 3 to the migration candidate information 134 (S64). On the other hand, when it is determined that a dependence virtual machine is not present, which is dependent on the virtual machine 3 detected by the processing of S61 (NO in S63), the information management unit 114 does not perform the processing of S63. Hereinafter, an example of migration state information when migration of the virtual machine 3E is completed will be described.

### Example (3) of Migration State Information

FIG. 26B illustrates migration state information when migration of the virtual machine 3E is completed.

In the migration state information described in FIG. 26A, the information with “virtual machine name” of “virtual machine A” and “virtual machine C” has “migration remaining time” of “2”, whereas the information with “virtual machine name” of “virtual machine E” has “migration remaining time” of “1”. Therefore, migration of the virtual machine 3E is first completed between the virtual machine 3A, the virtual machine 3C, and the virtual machine 3E.

Thus, in this case, as illustrated in FIG. 26B, the information management unit 114 moves “O” set for “migration determined” of the information with “virtual machine name” of “virtual machine E” to “migration completed”, and leaves “migration remaining time” blank, Also, as illustrated in FIGS. 26B, the information management unit 114 updates the value, from “2” to “1”, set for “migration remaining time” in the information with “virtual machine name” of “virtual machine A”, and “virtual machine C”.

Here, in the dependence virtual machine information 138 described in FIG. 18A, in the information with “virtual machine name” set to “virtual machine E”, “dependence virtual machine name” is set to “virtual machine B”. In other words, the virtual machine 3B becomes migratable to the physical machine 2 at a migration destination after completion of migration of the virtual machine 3E (YES in S63). Thus, as illustrated in FIG. 26B, the information management unit 114 moves “O” set for “migration incomplete” of the information with “virtual machine name” of “virtual machine B” to “migration candidate” (S64),

Returning to FIG. 12, the information management unit 114 determines whether or not information is present in the migration candidate information 134 (S65). When it is determined that information is present in the migration candidate information 134 (NO in S65), the information management unit 114 performs the processing in and after S51 again.

When it is determined that information is not present in the migration candidate information 134 (YES in S65), the information management unit 114 determines whether or not information is present in the migration determination information 135 (S66). When it is determined that information is present in the migration determination information 135 (YES in S66), the information management unit 114 performs the processing in and after S61 again.

On the other hand, when it is determined that information is not present in the migration determination information 135 (YES in S66), the information management unit 114 determines whether or not information is present in the migration incomplete information 136 (S67). When it is determined that information is present in the migration incomplete information 136 (YES in S67), the migration instruction unit 116 instructs the virtual machine 3 which has migrated by the processing of S56 to migrate back to the physical machine 2 at a migration source, and completes the migration control processing (S68). In other words, in this case, the migration instruction unit 116 determines that it is not possible to migrate the virtual machine 3 based on the migration target information 131. For this reason, in the processing of S68, the migration instruction unit 116 restores the allocation of each virtual machine 3 to the initial state.

Also, when it is determined that information is not present in the migration incomplete information 136 (NO in S67), the migration instruction unit 116 completes the migration control processing without performing the processing of S68. In other words, in this case, the migration instruction unit 116 determines that migration of all the virtual machines 3 has completed based on the migration target information 131.

For instance, in the migration state information described in FIG. 268, “migration candidate” of the information with “virtual machine name” of “virtual machine B” is set with “O” (YES in S65). Thus, the information management unit 114 performs the processing in and after S51 again. Hereinafter, an example of performing the processing in and after S51 after the processing of S65 will be described.

### Example of Performing Processing in and after S51 after Processing of S64

When information on the virtual machine 38 is extracted in the processing of S52, the information management unit 114 determines whether or a network, which has to be used for migration of the virtual machine 38 to the physical machine 2 at a migration destination, is available (S53).

For instance, when the virtual machine 38 is migrated from the physical machine 2A to the physical machine 2E, the virtual machine 38 goes through the networks with “network name” of “physical machine A->switch B”, “switch B->switch A”, “switch A->switch C”, and “switch C->physical machine E”.

Here, in the remaining network resource information 152 illustrated in FIG, 27, “migration number” in each information with “network name” of “switch B->switch A”, and “switch A->switch C” is set with “2” which is the value set for “migratable number”, Thus, in this case, the information management unit 114 determines that it is not possible to migrate the virtual machine 3B (NO in S53). Thus, as illustrated in FIG. 266, the information management unit 114 does not move “O” set for “migration candidate” of the information with “virtual machine name” of “virtual machine B” to “migration determined”,

Subsequently, when migration of the virtual machine 3A and the virtual machine 3C is completed (YES in S51, YES in S61), the information management unit 114 identifies the virtual machine 3D and the virtual machine 3F as migratable virtual machines 3 after completion of migration of the virtual machines 3A and 3C (YES in S63).

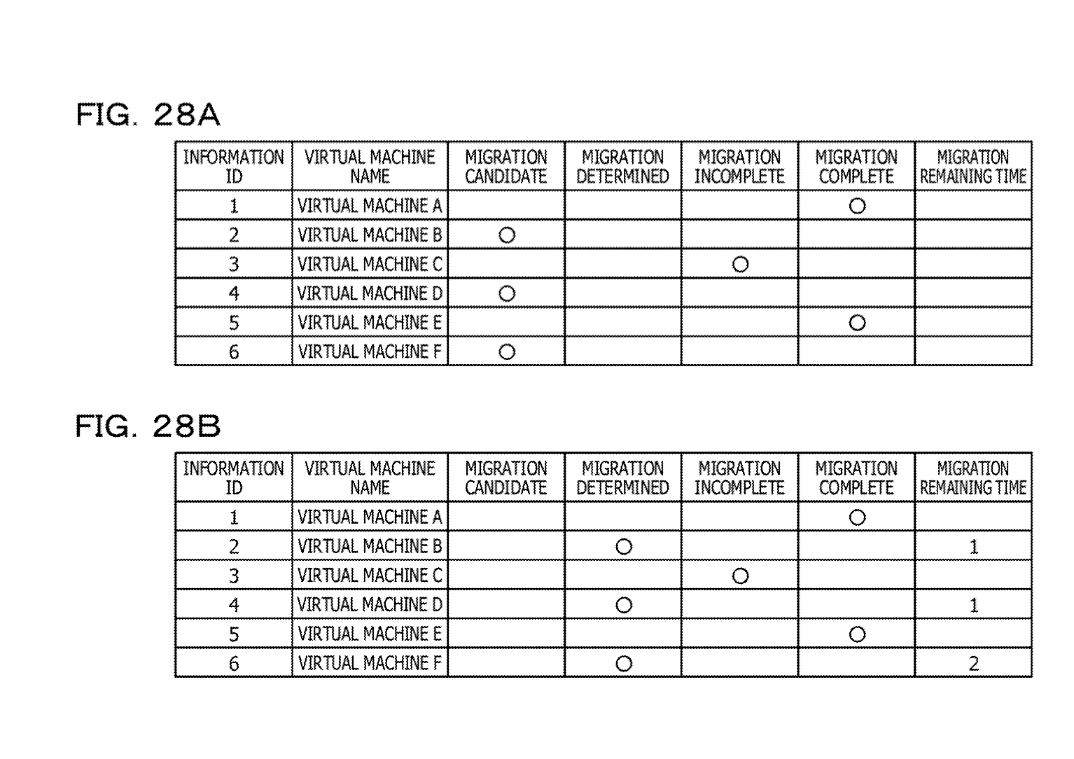

Thus, in this case, as illustrated in FIG. 28A, the information management unit 114 moves “O” set for “migration determined” of the information with “virtual machine name” of “virtual machine A” to “migration completed”, and leaves “migration remaining time” blank. Also, as illustrated in FIG. 28A, the information management unit 114 leaves “migration determined” of the information with “virtual machine name” of “virtual machine C” blank. It is to be noted that in the case illustrated in FIG. 28A, migration of the virtual machine 3C to the physical machine 2 at a migration destination is not completed. Therefore, as illustrated in FIG. 28A, the information management unit 114 does not set “migration completed” of the information with “virtual machine name” of “virtual machine C” to “O”. Thus, as illustrated in FIG. 28A, the information management unit 114 moves “O” set for “migration incomplete” of the information with “virtual machine name” of “virtual machine D” and “virtual machine F” to “migration candidate” (S64),

Subsequently, the information management unit 114 determines that the virtual machine 3B, the virtual machine 3D and the virtual machine 3F are concurrently migratable (YES in S53), and moves “O” set for “migration candidate” of the information of each virtual machine 3 as in the migration state information illustrated in FIG. 286. Then, in this case, the information management unit 114 sets “migration remaining time” of the information on the virtual machines 36, 3D, and 3F to “1”, “1”, and “2”, respectively as in the migration state information illustrated in FIG. 28B (S55). Subsequently, the migration instructions unit 116 instructs the virtual machine 36, the virtual machine 3D and the virtual machine 3F to migrate (S56).

Subsequently, when migration of the virtual machine 36 and the virtual machine 3D is completed (YES in S61), the information management unit 114 identifies the virtual machine 3C as migratable virtual machine 3 after completion of migration of the virtual machines 36 and 3D (YES in S63).

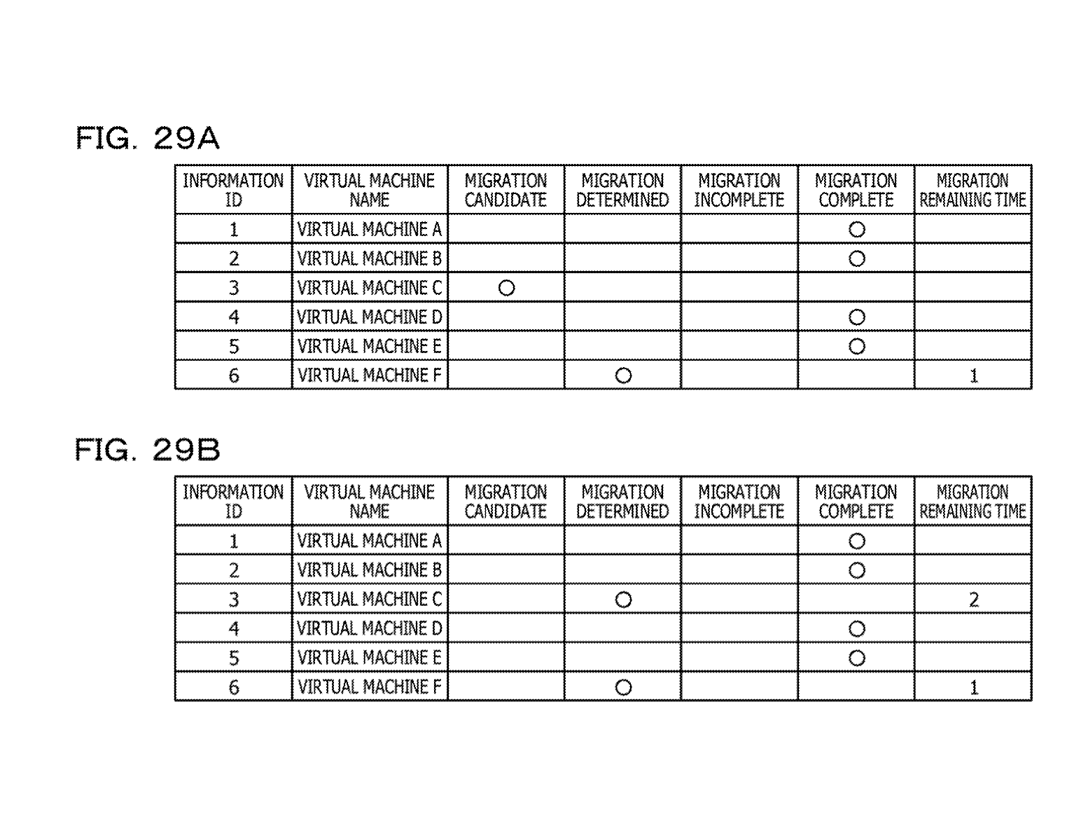

Thus, in this case, as illustrated in FIG. 29A, the information management unit 114 moves “O” set for “migration determined” of the information with “virtual machine name” of “virtual machine B” and “virtual machine D” to “migration completed”, and leaves “migration remaining time” blank. Also, as illustrated in FIG. 29A, the information management unit 114 moves “O” set for “migration incomplete” of the information with “virtual machine name” of “virtual machine C” to “migration candidate” (S64).

Subsequently, the information management unit 114 determines that the virtual machine 3C is migratable (YES in S53), and moves “O” set for “migration candidate” of the information of the virtual machine 3C as in the migration state information illustrated in FIG. 298, Then, in this case, the information management unit 114 sets “migration remaining time” of the information on the virtual machine 3C to “2” as in the migration state information illustrated in FIG. 29B (S55). Subsequently, the migration instruction unit 116 instructs the virtual machine 3C to migrate (S56).

Then, when migration of the virtual machine 3F is completed (YES in S61), the information management unit 114 determines that no migratable virtual machine 3 is present after completion of migration of the virtual machines 3F (NO in S63). Although no information is set for the migration candidate information 134, information is set for the migration determination information 135 (YES in S65, YES in S66).

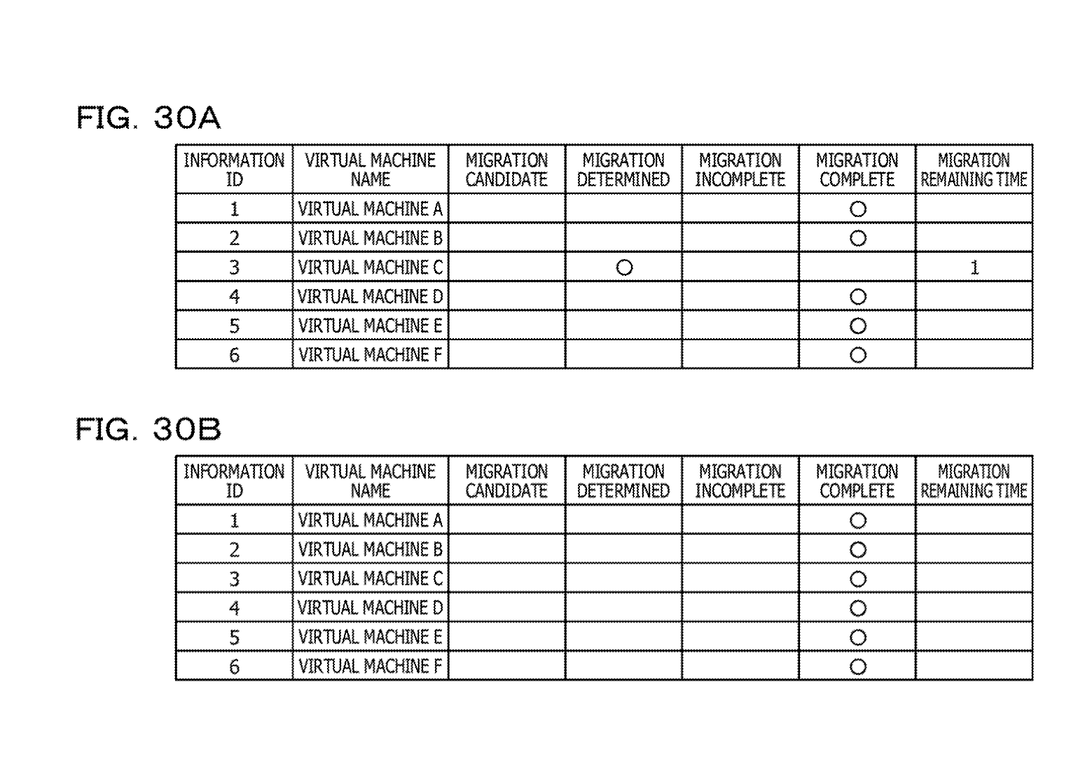

Thus, as illustrated in FIG. 30A, the information management, unit 114 moves “O” set for “migration determined” of the information with “virtual machine name” of “virtual machine F” to “migration completed”, and leaves “migration remaining time” blank, Also, as illustrated in FIG. 30A, the information management unit 114 updates the value, from “2” to “1”, set for “migration remaining time” in the information with “virtual machine name” of “virtual machine C”.

Subsequently, when migration of the virtual machine 3C is completed (YES in S61), the information management unit 114 determines that no migratable virtual machine 3 is present after completion of migration of the virtual machines 3C (NO in S63). In this case, no information is set for the migration candidate information 134 and the migration determination information 135 (YES in S65, NO in S66). Furthermore, no information is set for “migration incomplete” in the migration state information illustrated in FIG. 30A (NO in S67). Thus, the information processing apparatus 1 completes the migration control processing. That is, in this case, the information processing apparatus 1 determines that migration of the virtual machine 3 is completed based on the migration target information 131.

In this manner, the information processing apparatus 1 in this embodiment determines a priority of each virtual machine 3 based on the time information 131a that indicates the time taken for migration of each virtual machine 3 between the physical machines 2. The information processing apparatus 1 then identifies the first virtual machine group that includes virtual machines 3 each migratable to the physical machine 2 at a migration destination, based on the migration information 131 on the physical machines 2 at a migration source and a migration destination of each virtual machine 3, and on the first state information 132a that indicates the state of each physical machine 2 and each virtual machine 3. In addition, the information processing apparatus 1 instructs each virtual machine 3 included in the first virtual machine group to migrate to the physical machine 2 at a migration destination based on the priority of the virtual machine 3.

Subsequently, the information processing apparatus 1 identifies the second virtual machine group that includes virtual machines 3 each migratable to the physical machine 2 at a migration destination based on the migration information and the second state information 132b indicating the state of each physical machine 2 and each virtual machine 3 when migration of one of the virtual machines 3 is completed. The information processing apparatus 1 then instructs each virtual machine 3 included in the second virtual machine group to migrate to the physical machine 2 at a migration destination based on the priority of the virtual machine 3.

Thus, when multiple migratable virtual machines 3 are present in the physical machine 2 at a migration destination, the information processing apparatus 1 is able to migrate a virtual machine 3 that produces the greatest effect on reducing the time taken for migration of all the virtual machines 3. Thus, even when the times taken for migration of the virtual machines 3 are varied, it is possible for the information processing apparatus 1 to determine an order of migration that reduces the tine taken for migration of all the virtual machines 3.

Also, in response to a change in available state of the physical resource of each physical machine 2, the information processing apparatus 1 is able to identify a new virtual machine 3 which has become migratable. Thus, it is possible for the information processing apparatus 1 to update selection of a virtual machine 3 as desired for instructing migration to the physical machine 2 at a migration destination. Therefore, it is possible for the information processing apparatus 1 to search for an order of migration for reallocating virtual machines 3 based on the optimal allocation of the virtual machines 3.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory storage medium storing a program that causes a computer to execute a process, the process comprising:
for each of a plurality of virtual machines set as targets for migration between a plurality of physical machines included in an information processing system, first obtaining information on a virtual machine from among the plurality of virtual machines, migration information, first state information, and time information, the migration information including information in which information on a physical machine at a migration source of the virtual machine and information on a physical machine at a migration destination of the virtual machine are associated with each other, the first state information indicating a state of each of the plurality of physical machines and the plurality of virtual machines, the time information indicating a time taken for the migration of each of the plurality of virtual machines between the plurality of physical machines;
first determining a priority of each of the plurality of virtual machines based on the time information;
first identifying a first virtual machine group based on the migration information and the first state information, the first virtual machine group including each virtual machine which is migratable to the physical machine of the migration destination, among the plurality of virtual machines;
first instructing each virtual machine included in the first virtual machine group to migrate to the physical machine of the migration destination respectively, based on the determined priority;
in response to completion of the migration of one virtual machine included in the first virtual machine group to the physical machine of the migration destination, second obtaining second state information indicating a state of each of the plurality of physical machines and the plurality of virtual machines;
second identifying a second virtual machine group based on the migration information and the second state information, the second virtual machine group including each virtual machine which is migratable to the physical machine of the migration destination, among the plurality of virtual machines; and
second instructing each virtual machine included in the second virtual machine group to migrate to the physical machine of the migration destination respectively, based on the determined priority.

2. The non-transitory storage medium according to claim 1, wherein
the process further comprises:
before the first determining, second determining whether or not a first dependence virtual machine which is a virtual machine that has to be first migrated is present in order to migrate each of the plurality of virtual machines to the physical machine of the migration destination respectively,
the first determining includes:
when the second determining determines that the first dependence virtual machine is present, third determining that the priority of each virtual machine other than the first dependence virtual machine is the time information corresponding to the virtual machine other than the first dependence virtual machine from among the plurality of virtual machines,
when the second determining determines that the first dependence virtual machine is not present, fourth determining that the priority of each of the plurality of virtual machines is the time information corresponding to the virtual machine,
when priorities of all of the plurality of virtual machines are undetermined, fifth determining whether or not a second dependence virtual machine which is a virtual machine that has to be first migrated is present in order to migrate each of the virtual machines with the priority undetermined to the physical machine of the migration destination,
when it is determined that the second dependence virtual machine is present, sixth determining that the priority of each virtual machine other than the second dependence virtual machine among the virtual machines with the priorities undetermined is a sum of the time information corresponding to the virtual machine other than the second dependence virtual machine among the virtual machines with the priorities undetermined, and the priority of the virtual machine which becomes migratable to the physical machine of the migration destination by first migrating a virtual machine other than the second dependence virtual machine among the virtual machines with the priorities undetermined,
when it is determined that the second dependence virtual machine is not present, seventh determining that the priority of each virtual machine of the virtual machines with the priorities undetermined is a sum of the time information corresponding to the virtual machine of the virtual machines with the priorities undetermined, and the priority of the virtual machine which becomes migratable to the physical machine of the migration destination by prior migration of the virtual machine with the priority undetermined, and
first repeating the fifth determining and the seventh determining until the priority of each of the plurality of virtual machines is determined, and
the first instructing and the second instructing instruct a virtual machine higher in the priority to migrate earlier to the physical machine of the migration destination respectively.

3. The non-transitory storage medium according to claim wherein
the process further comprises:
before the first determining, eighth determining whether or not a dependence virtual machine group is present, the dependence virtual machine group including the first dependence virtual machine and two or more virtual machines that have a circulated relationship between the first dependence virtual machine and a virtual machine which becomes migratable to the physical machine of the migration destination by prior migration of the first dependence virtual machine,
the third determining includes:
when it is determined that the dependence virtual machine group is present, for each of the every dependence virtual machine group, calculating a sum value of a smallest value of the time information corresponding to a virtual machine included in each dependence virtual machine group, and the time information corresponding to the first dependence virtual machine of a virtual machine corresponding to the smallest value of the time information corresponding to a virtual machine included in each dependence virtual machine group, and
ninth determining that the priority of each first dependence virtual machine of the virtual machine corresponding to the smallest value of the time information is the calculated value.

4. The non-transitory storage medium according to claim 3, wherein the two or more virtual machines having the circulated relationship are two or more virtual machines having a relationship in which each virtual machine included in the two or more virtual machines from among first dependence virtual machines is the first dependence virtual machine of another virtual machine included in the two or more virtual machines, and the first dependence virtual machine of each virtual machine included in the two or more virtual machines is the another virtual machine included in the two or more virtual machines.

5. The non-transitory storage medium according to claim 3, wherein the first identifying includes:
for each of the dependence virtual machine group, identifying the first dependence virtual machine of a virtual machine having the smallest value of the time information among virtual machines included in the dependence virtual machine group, the virtual machine being of the plurality of virtual machines and not migratable to the physical machine of the migration destination, and identifying the identified first dependence virtual machine having the smallest value of the time information as part of the first virtual machine group.

6. The non-transitory storage medium according to claim 1, wherein the first state information and the second state information include, respectively, information on an available capacity of a physical resource of each of the plurality of physical machines, and information on an amount of use of the physical resource used for operating each of the plurality of physical machines.

7. The non-transitory storage medium according to claim 6, wherein the first identifying and the second identifying identify, respectively, a virtual machine having the amount of use of the physical resource smaller than the available capacity of the physical resource in the physical machine of the migration destination among the plurality of virtual machines, as a virtual machine that is migratable to the physical machine of the migration destination.

8. The non-transitory storage medium according to claim 1, wherein
the process further comprises:
before the first instructing, third obtaining first migratable information that indicates the number of virtual machines concurrently migratable between the plurality of physical machines,
before the second instructing, fourth obtaining second migratable information that indicates the number of virtual machines concurrently migratable between the plurality of physical machines,
the first instructing includes:
referring to the first migratable information, and
instructing, to the physical machine of the migration destination, a virtual machine which is included in the first virtual machine group and for which the number of virtual machines being migrated from the physical machine of the migration source to the physical machine of the migration destination is smaller than the number of virtual machines concurrently migratable from the physical machine of the migration source to the physical machine of the migration destination, and
the second instructing includes:
referring to the second migration information, and
instructing, to the physical machine of the migration destination, a virtual machine which is included in the second virtual machine group and for which the number of virtual machines being migrated from the physical machine of the migration source to the physical machine of the migration destination is smaller than the number of virtual machines concurrently migratable from the physical machine of the migration source to the physical machine of the migration destination.

9. The non-transitory storage medium according to claim 1, wherein the first identifying and the second identifying complete, respectively, migration of the virtual machine when a virtual machine that has not been instructed to migrate to the physical machine of the migration destination is not present in the plurality of virtual machines.

10. The non-transitory storage medium according to claim 1, wherein the first identifying and the second identifying, when a virtual machine that has not been instructed to migrate to the physical machine of the migration destination is present and a virtual machine migratable to the physical machine of the migration destination is not present in the plurality of virtual machines, instruct a virtual machine, which has been instructed to migrate to the physical machine of the migration destination, to migrate back to the physical machine of the migration source, and completes the migration of the virtual machine.

11. The non-transitory storage medium according to claim 1, wherein the process further comprises:
after the second instructing, second repeating the second obtaining, the second identifying and the second instructing until no virtual machine that has not been instructed to migrate to the physical machine of the migration destination becomes present, or until a virtual machine that has not been instructed to migrate to the physical machine of the migration destination is, present and no virtual machine migratable to the physical machine of the migration destination becomes present, under a condition that a virtual machine that has not been instructed to migrate to the physical machine of the migration destination is present in the plurality of virtual machines.

12. A method executed by a computer, the method comprising:
for each of a plurality of virtual machines set as targets for migration between a plurality of physical machines included in an information processing system, first obtaining information on a virtual machine from among the plurality of virtual machines, migration information, first state information, and time information, the migration information including information in which information on a physical machine at a migration source of the virtual machine and information on a physical machine at a migration destination of the virtual machine are associated with each other, the first state information indicating a state of each of the plurality of physical machines and the plurality of virtual machines, the time information indicating a time taken for the migration of each of the plurality of virtual machines between the plurality of physical machines;
first determining a priority of each of the plurality of virtual machines based on the time information;
first identifying a first virtual machine group based on the migration information and the first state information, the first virtual machine group including each virtual machine which is migratable to the physical machine of the migration destination, among the plurality of virtual machines;
first instructing each virtual machine included in the first virtual machine group to migrate to the physical machine of the migration destination respectively, based on the determined priority;
in response to completion of the migration of one virtual machine included in the first virtual machine group to the physical machine of the migration destination, second obtaining second state information indicating a state of each of the plurality of physical machines and the plurality of virtual machines;
second identifying a second virtual machine group based on the migration information and the second state information, the second virtual machine group including each virtual machine which is migratable to the physical machine of the migration destination, among the plurality of virtual machines; and
second instructing each virtual machine included in the second virtual machine group to migrate to the physical machine of the migration destination respectively, based on the determined priority.

13. A device comprising:
a memory; and
a processor coupled to the memory and configured to:
for each of a plurality of virtual machines set as targets for migration between a plurality of physical machines included in an information processing system, obtain information on a virtual machine from among the plurality of virtual machines, migration information, first state information, and time information, the migration information including information in which information on a physical machine at a migration source of the virtual machine and information on a physical machine at a migration destination of the virtual machine are associated with each other, the first state information indicating a state of each of the plurality of physical machines and the plurality of virtual machines, the time information indicating a time taken for the migration of each of the plurality of virtual machines between the plurality of physical machines,
determine a priority of each of the plurality of virtual machines based on the time information,
identify a first virtual machine group based on the migration information and the first state information, the first virtual machine group, including each virtual machine which is migratable to the physical machine of the migration destination, among the plurality of virtual machines,
instruct each virtual machine included in the first virtual machine group to migrate to the physical machine of the migration destination respectively, based on the determined priority,
in response to completion of the migration of one virtual machine included in the first virtual machine group to the physical machine of the migration destination, obtain second state information indicating a state of each of the plurality of physical machines and the plurality of virtual machines,
identify a second virtual machine group based on the migration information and the second state information, the second virtual machine group including each virtual machine which is migratable to the physical machine of the migration destination, among the plurality of virtual machines, and
instruct each virtual machine included in the second virtual machine group to migrate to the physical machine of the migration destination respectively, based on the determined priority.
